(19) United States
(12) Patent Application Publication
(10) Pub. No.: US 2007/0162547 A1
(43) Pub. Date: Jul. 12, 2007

(54) Methods and apparatus for community organization

(75) Inventor: Matthew A. Ross, Cambridge, MA (US)

Correspondence Address: LAHIVE & COCKFIELD, LLP, ONE POST OFFICE SQUARE, BOSTON, MA, 02109-2127, US

(73) Assignee: Groope.com LLC, Cambridge, MA (US)

(21) Appl. No.: 11/652,923

(22) Filed: Jan. 11, 2007

Related U.S. Application Data
(60) Provisional application No. 60/758,045, filed on Jan. 11, 2006.

(51) Int. Cl. G06F 15/16

(52) U.S. Cl. 709/204

(57) ABSTRACT

The present invention provides methods, systems, and components for bringing together individuals into an organization of groups in an online environment and for providing ways to help groups keep in contact and manage affairs. The groups are organized such that members of any particular group share some common interest or activity. A group could be an online representation of a group, club, community, team, school, alumni, friends, singles, families, organizations or businesses, for example. The present invention allows users to join an online community; create and maintain public or private interest groups; search member messages, biographies, photos, and news; add events to a group calendar; use online RSVP and automated guest lists to manage events; manage projects with interactive task lists, budgeting tools, and progress reports; schedule online chat; vote on group decisions; and generally connect with others in an online environment.

### RELATED APPLICATION

This application claims the benefit of U.S. Provisional Patent Application Ser. No. 60/758,045, filed Jan. 11, 2006, the contents of which are hereby incorporated by reference.

### FIELD OF THE INVENTION

The present invention relates generally to methods, systems, and apparatus for organizing a community of members and, in particular, relates to methods, systems, and apparatus for organizing communities through a client-server network.

### BACKGROUND OF THE INVENTION

Using the internet to congregate in virtual communities is well known. Email, instant messaging, bulletin boards, and forums, are all capable of creating a sense of community among users who persistently communicate with a group of people sharing one or more common interests.

Software that organizes a user's information is also well known. Calendar programs are used to keep track of events. Invitation software are used to send invitations for events, generate and track responses, and manage event details. Project management programs allow a user to map out a project, divide the project into tasks, and track the progress of each task.

### SUMMARY OF THE INVENTION

The present invention provides methods, systems, and components for bringing together individuals into an organization of groups in an online environment and for providing ways to help groups keep in contact and manage affairs. The groups are organized such that members of any particular group share some common interest or activity. A group could be an online representation of a group, club, community, team, school, alumni, friends, singles, families, organizations or businesses, for example. The present invention allows users to join an online community; create and maintain public or private interest groups; search member messages, biographies, photos, and news; add events to a group calendar; use online RSVP and automated guest lists to manage events; manage projects with interactive task lists, budgeting tools, and progress reports; schedule online chat; vote on group decisions; and generally connect with others in an online environment.

### BRIEF DESCRIPTION OF THE FIGURES

FIG. 1 is a schematic diagram of a conventional digital processing system in which the present invention can be deployed.

FIG. 2 is a schematic diagram of a conventional PC or other computing apparatus in which the present invention can be deployed.

FIGS. 3A-3C depict a web page describing different types of groups in an online community.

FIGS. 4A-4D depict a home page for an online community.

FIGS. 5A-5F depict a home page for a group.

FIGS. 6A-6B depict a web page for voting on a group name.

FIGS. 7A-7D depict a web page for searching for a group.

FIG. 8 depict a web page displaying results of a search.

FIG. 9 depicts a web page for joining a group.

FIGS. 10A-10B depict a web page for displaying a user's groups.

FIGS. 11A-11B depict a web page for creating a group.

FIGS. 12A-12B depict a web page for displaying a summary of recent activity in a user's groups.

FIGS. 13A-13B depict a web page for sponsoring a new member of a group.

FIG. 14 depicts a web page displaying links to user account settings.

FIGS. 15A-15F depict a web page for editing profile settings.

FIG. 16 depicts a web page for managing a user's photos.

FIG. 17 depicts a web page for viewing a photo.

FIGS. 18A-18C depict a web page for searching for group members.

FIGS. 19A-19B depict a web page displaying group member search results.

FIGS. 20A-20B depict a web page of a user's profile.

FIGS. 21A-21C depict a web page describing project management.

FIGS. 22A-22C depict a web page displaying a project list.

FIG. 23 depicts a web page displaying project data.

FIGS. 24A-24I depict a web page displaying a task list.

FIGS. 25A-25B depict a web page displaying task data.

FIGS. 26A-26D depict a web page for adding a task.

FIGS. 27A-27B depict a web page displaying a summary of progress in a project.

FIGS. 28A-28B depict a web page displaying information about adding multiple tasks to a task list.

FIGS. 29A-29B depict a web page displaying a calendar in a view.

FIG. 30 depicts a web page displaying a calendar in an alternate view.

FIG. 31 depicts a web page displaying information about a calendar event.

FIG. 32 depicts a web page displaying an RSVP list.

FIGS. 33A-33C are a web page for posting a new event.

FIG. 34 depicts a web page displaying recent polls.

FIG. 35 depicts a web page displaying upcoming and closed polls.

FIG. 36 depicts a web page for voting in a poll.

FIG. 37 depicts a web page for creating a new poll.

FIG. 38 depicts a web page for conducting a chat session.

FIGS. 39A-39G depict a web page displaying a message board.

FIG. 40 depicts a web page for posting a new message to the message board.

FIG. 41 depicts a web page detailing participation costs.

FIG. 42 depicts a web page for contacting the site administrators.

FIG. 43 depicts a web page displaying advertising options.

FIGS. 44A-44B depict a web page for adding an advertisement.

### DETAILED DESCRIPTION

Before proceeding with detail of the embodiments and practices of the present invention, the following is a brief discussion of the typical aspects of a computing environment in which the invention may be implemented.

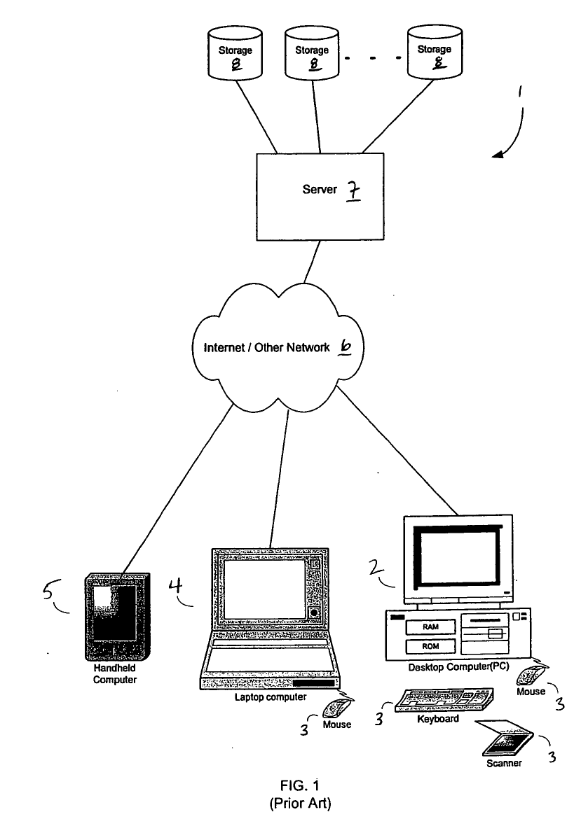

In particular, methods, devices or software products in accordance with the invention can operate on any of a wide range of conventional computing devices and systems, like those depicted by way of example in FIG. 1 (e.g., a network system 1), whether standalone, networked, portable or fixed, including conventional PCs 2, laptops 4, handheld or mobile computers 5, or across the Internet or other networks 6, which may in turn include servers 7 and storage 8.

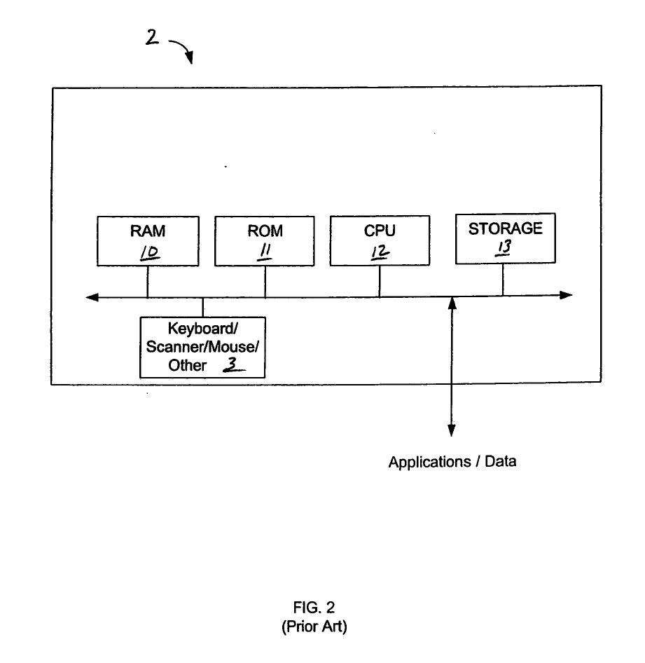

In line with conventional computer software and hardware practice, a software application configured in accordance with the invention can operate within, e.g., a PC 2 like that shown in FIG. 2, in which program instructions can be read from CD ROM 11, magnetic disk or other storage 13 and loaded into RAM 10 for execution by CPU 12. Data can be input into the system via any known device or means, including a conventional keyboard, scanner, mouse or other elements 103.

Having described a typical environment in which the invention may be implemented, the following discussion describes methods, systems, and apparatus in accordance with the present invention for bringing together individuals into an organization of groups in an online environment and for providing ways to help groups keep in contact and manage affairs. It will be understood by those skilled in the art that the below-described methods, systems, and apparatus can be implemented in software, hardware, or a combination of software and hardware, using conventional computer apparatus such as a personal computer (PC) or equivalent device operating in accordance with (or emulating) a conventional operating system such as Microsoft Windows, Linux, or Unix, either in a standalone configuration or across a network. The various processing means and computational means described below and recited in the claims may therefore be implemented in the software and/or hardware elements of a properly configured digital processing device or network of devices.

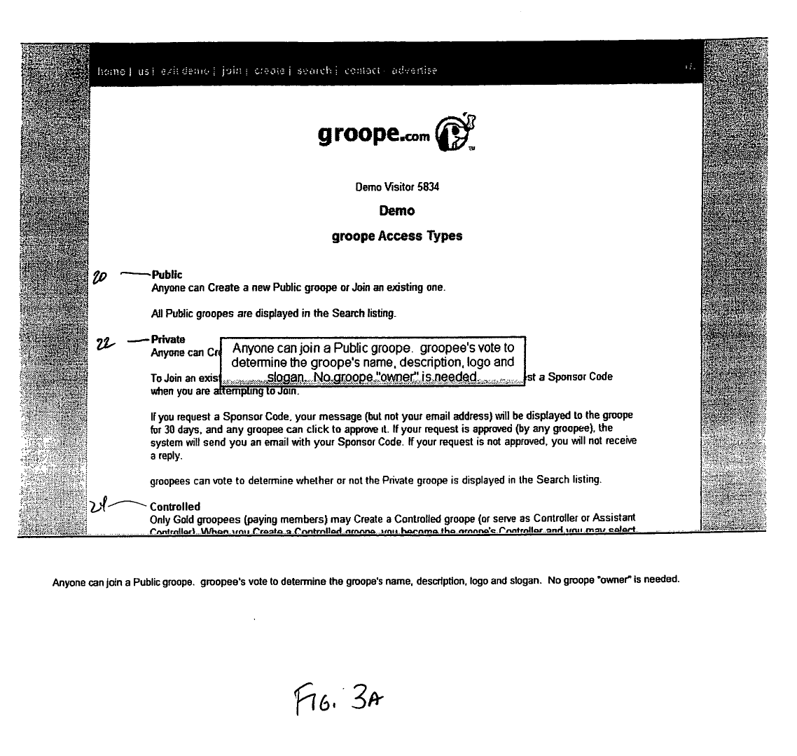

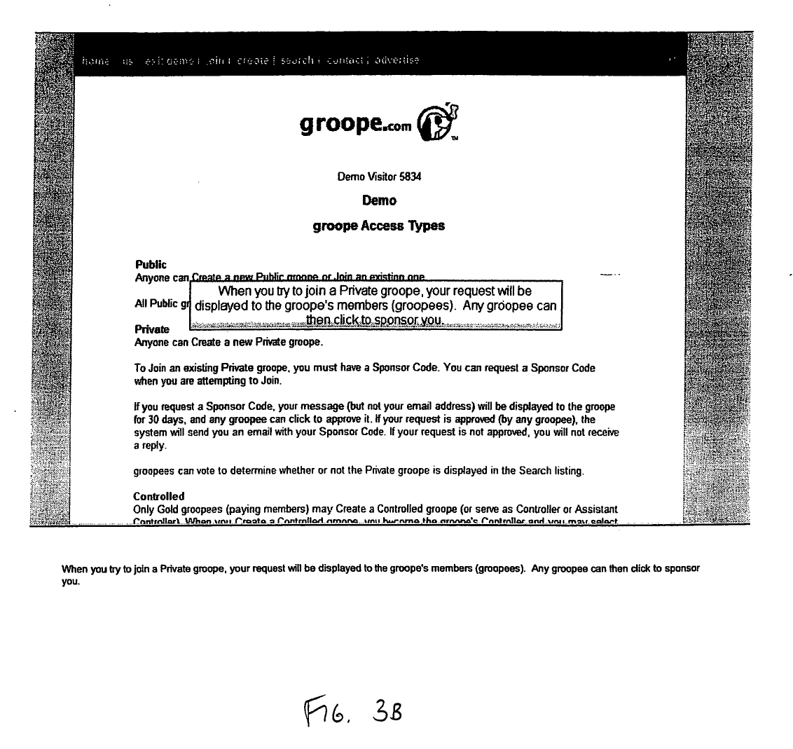

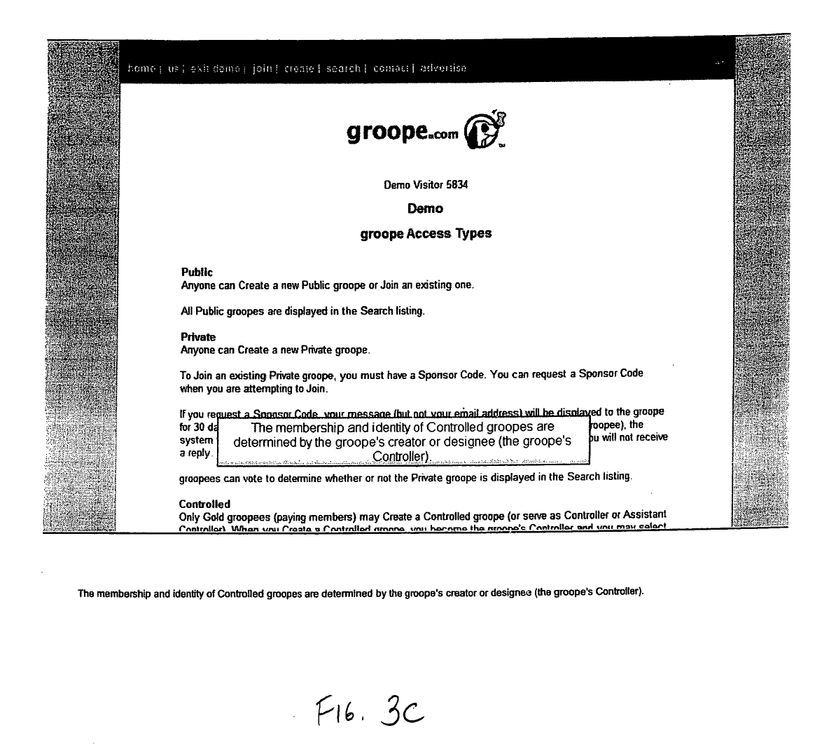

Referring to FIGS. 3A-3C, an embodiment of the present invention permits three types of groups with increasing degrees of control: public groups 20, private groups 22, and controlled groups 24.

A public group 20 may be created by anyone. Once created, anyone may join public group 20, as described in more detail below. Members of group 20 control its properties through a process of nominations and voting. The winning choice (e.g., the super-majority choice) is implemented automatically. In this way, public groups 20 do not require a dedicated moderator.

A private group 22 may also be created by anyone. But once created, membership is controlled in the first instance by the creator of the private group 22 and then by all subsequent members of group 22. Existing members of group 22 can extend an invitation to prospective new members. Alternatively, a prospective member can request to become a new member. In response to the request, an existing member can allow it, effectively sponsoring the new member. If no existing member will be a sponsor, the request is denied after a suitable period of time, such as 30 days.

Controlled groups 24 may only be created by a limited group of members, such as those who choose to pay for a subscription. The creator of a controlled group 24 becomes the group's Controller and can control group 24's properties and settings, such as whether controlled group 24 is displayed in search listings. The Controller may select an Assistant Controller, who is granted similar control over group 24 and will succeed the Controller should he resign from group 24. Should the Controller resign without an Assistant Controller in place, controlled group 24 automatically converts to a private group.

Membership in controlled group 24 operates in a similar manner as for private group 22, using invitations and sponsorships, except that only the Controller and Assistant Controller may invite or sponsor new members. The Controller and Assistant Controller may warn members of controlled group 24 and, after a certain number of warnings, may remove a member from group 24. In one example, three warnings are required for removal. Controlled group 24 may have both subscribing members and non-subscribing members.

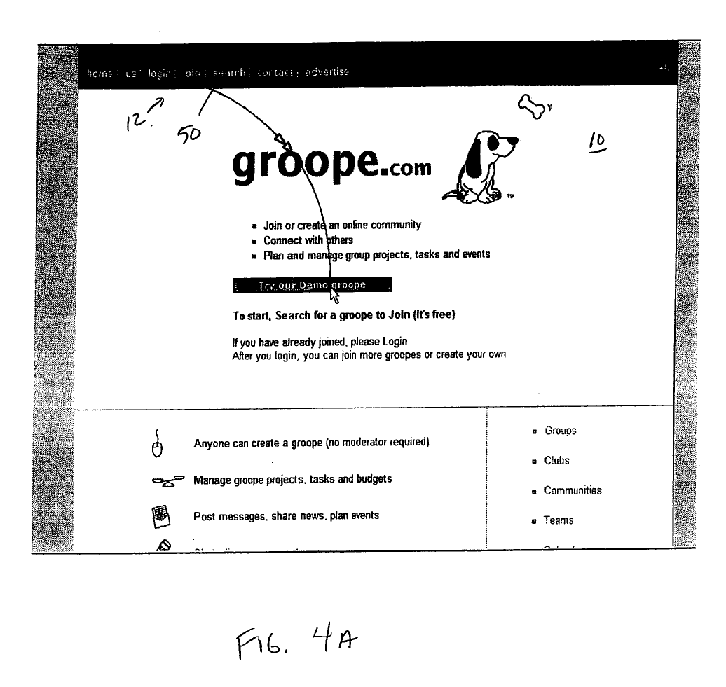

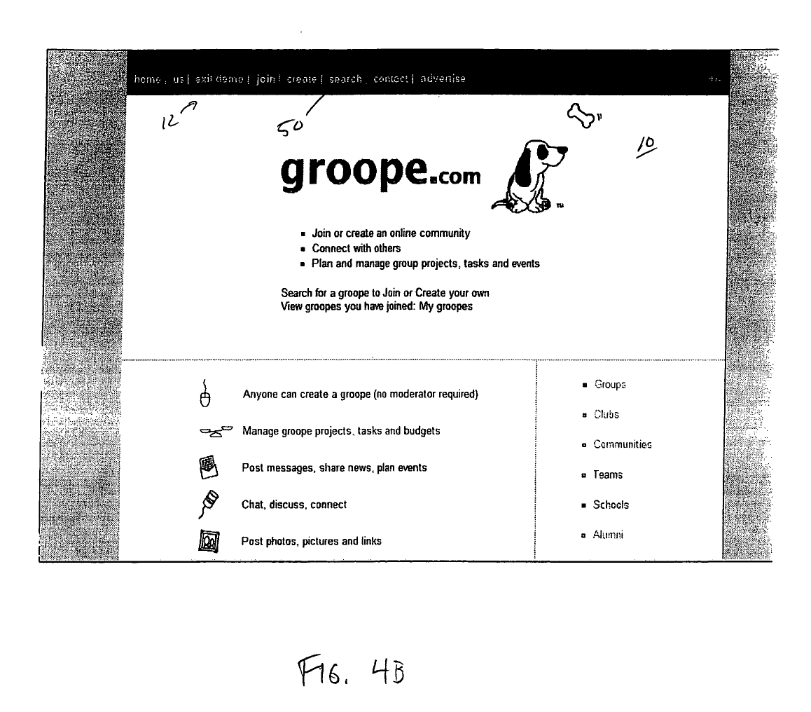

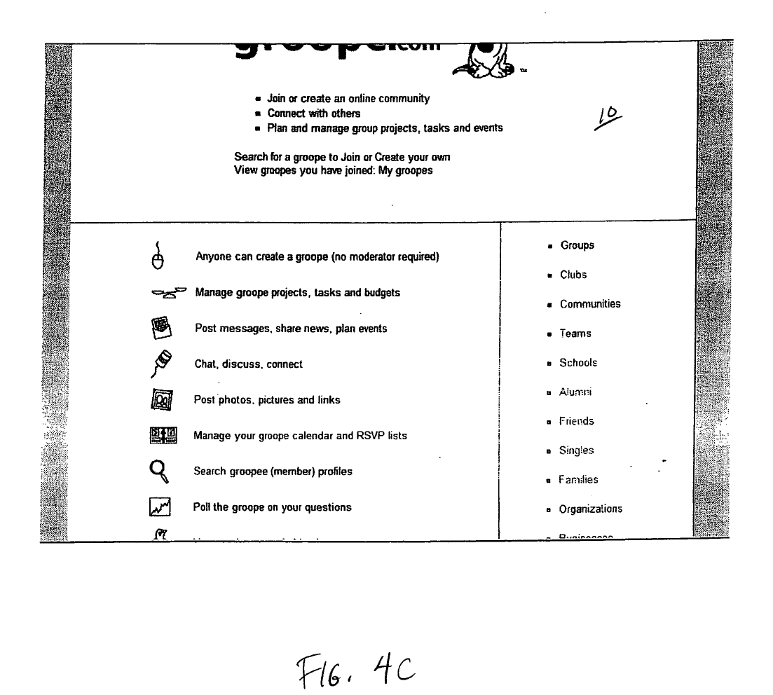

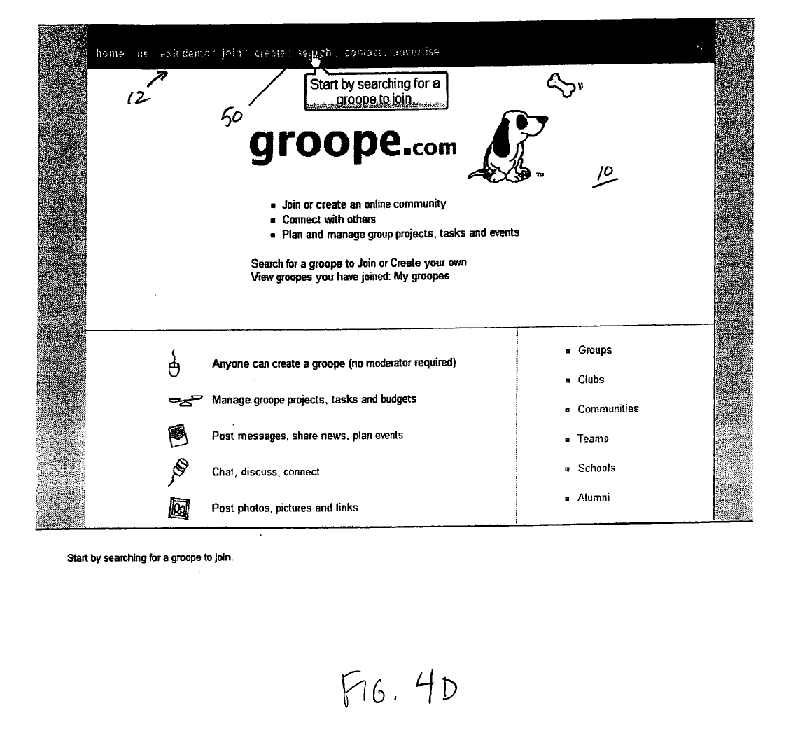

Referring to FIGS. 4A-4D, in one embodiment of the present invention, a user navigates to a home page 10 of the embodiment on the World Wide Web using a web browser. Those skilled in the art will understand that the present invention is not limited to a web-based implementation. In one example, page 10 displays a welcome message and describes features of the embodiment. A list of links 12 to other pages is displayed across the top of page 10.

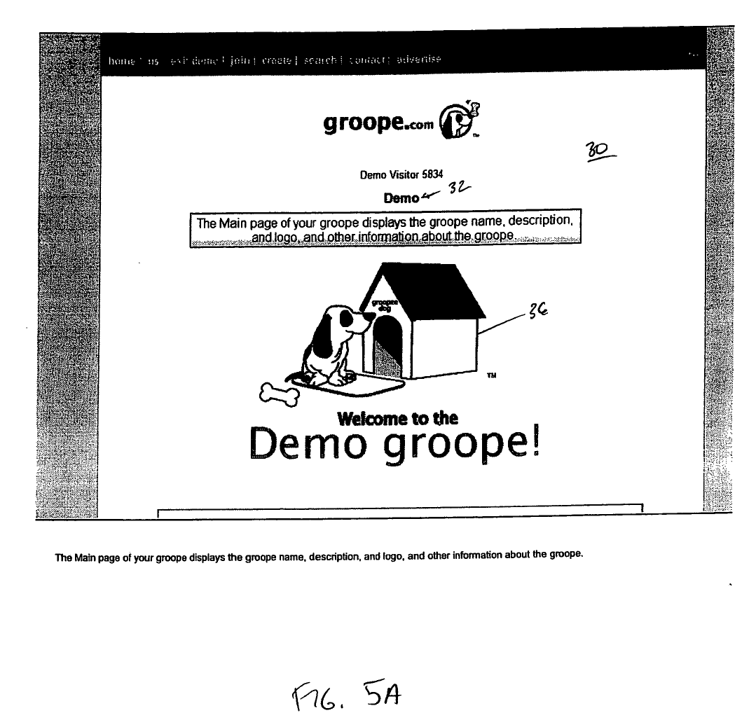

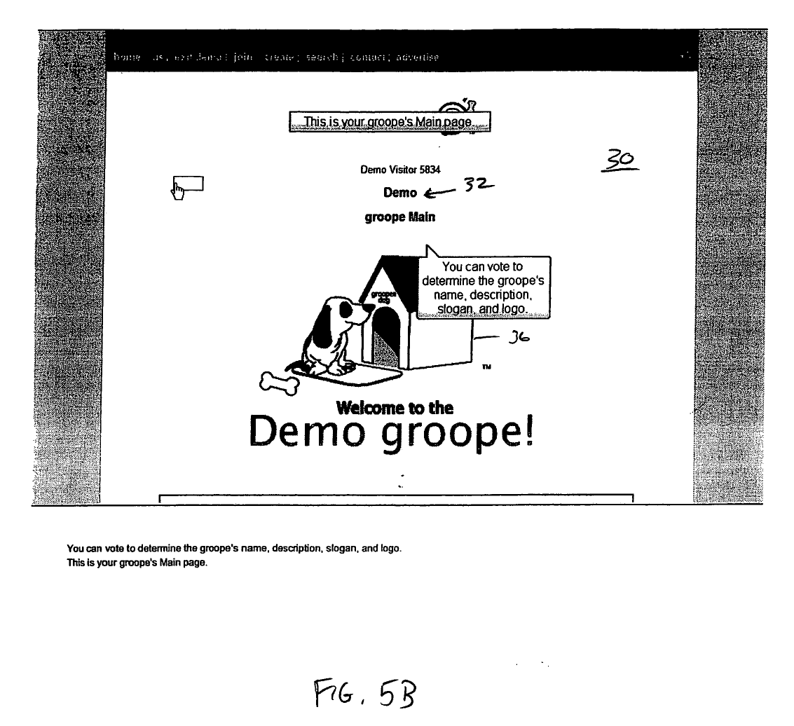

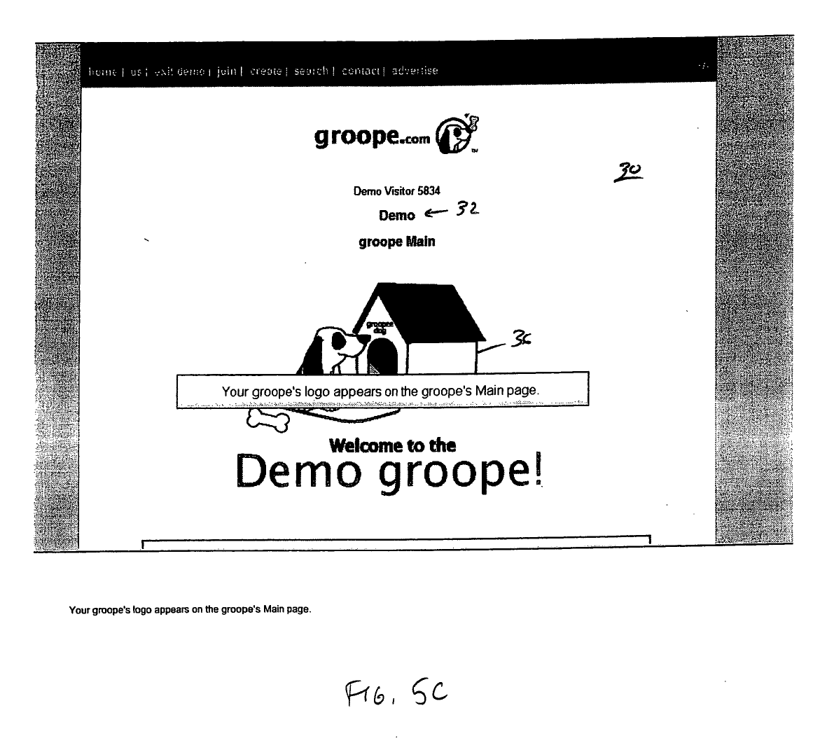

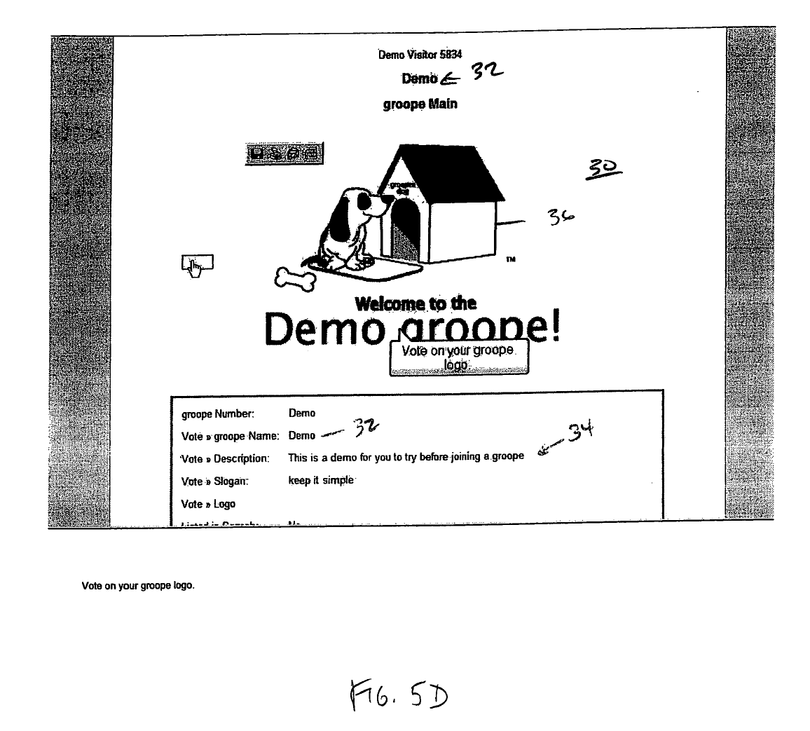

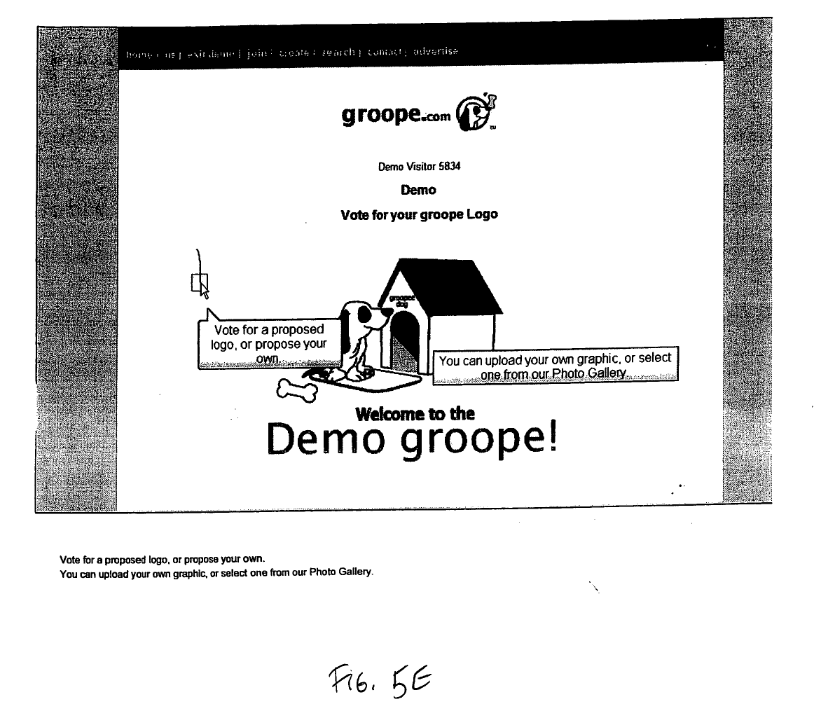

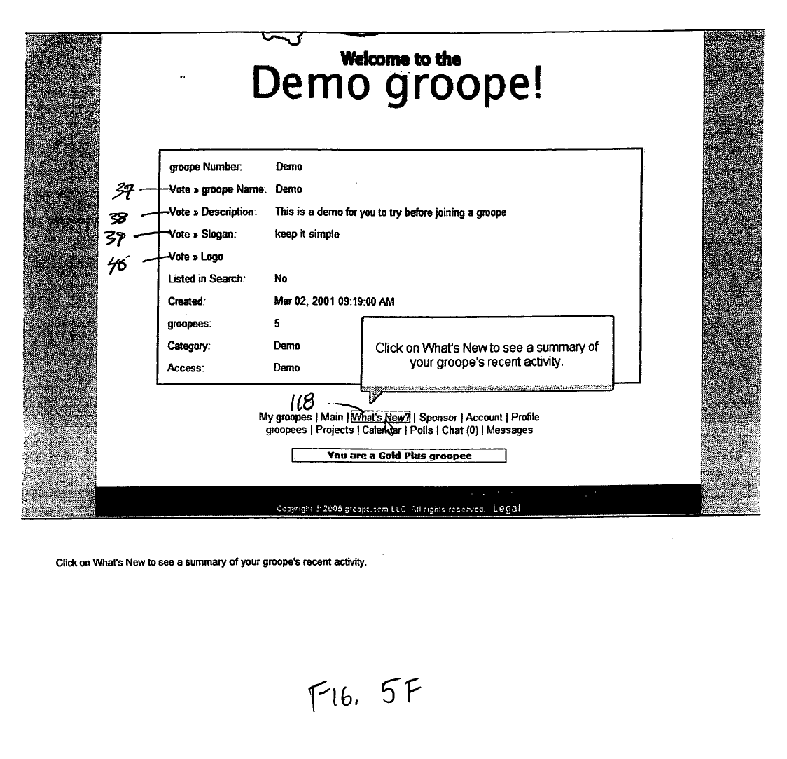

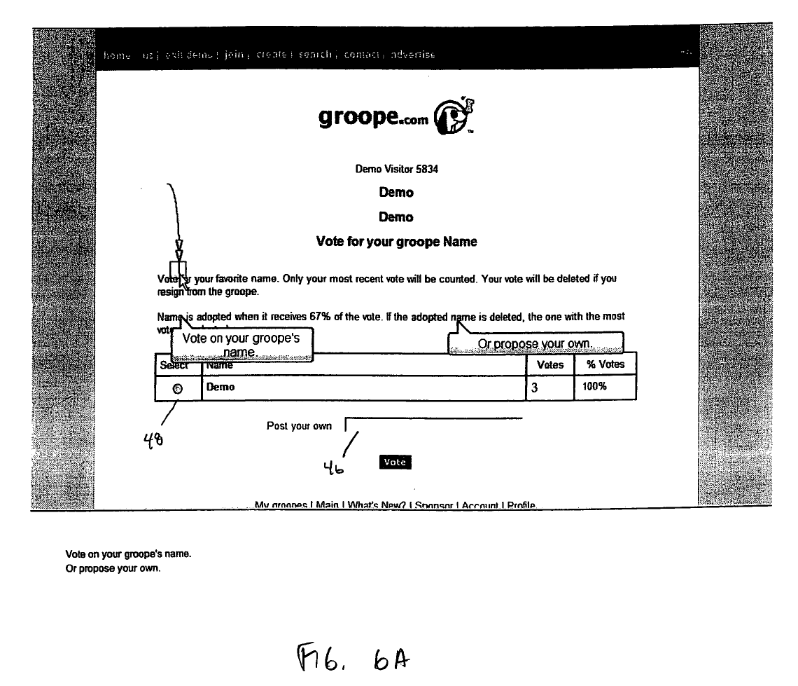

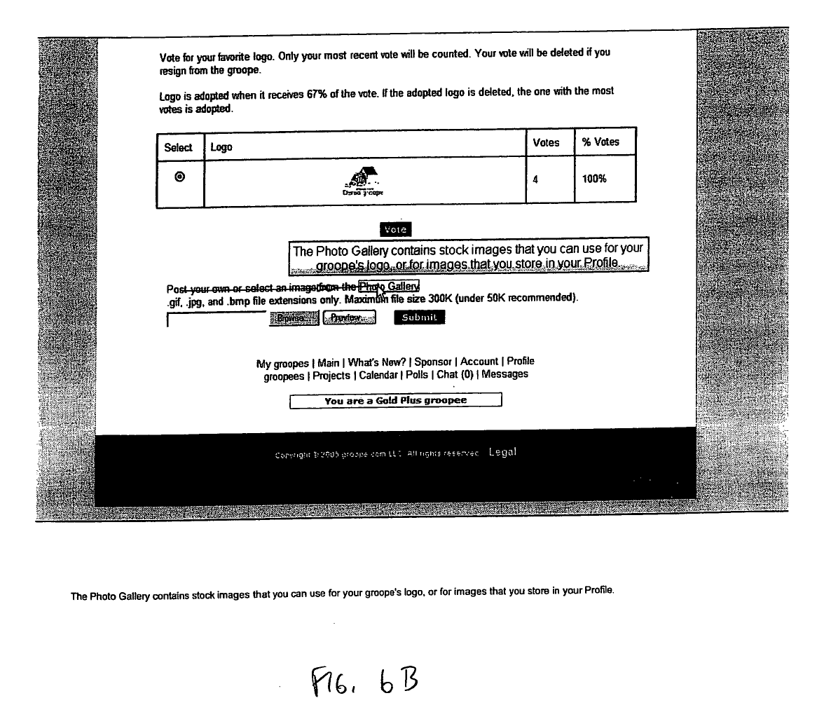

Referring to FIGS. 5A-5F and 6A-6B, the main page 30 of a public group 20 is shown. Main page 30 displays the group name 32 (e.g., “Demo”), group description 34, group logo 36, and other information about the group. Links 37, 38, 39, and 40 are displayed to lead group members to pages where they can propose new group names, descriptions, slogans, logos, or the like, and vote on existing proposals. Users can upload their own proposed logo graphics or photos, or select from the site's graphics and photo gallery. The site's graphics and photo gallery may be searched or sorted by category, image name, keywords, or identification number. For example, a member of the Demo group can propose a new group name by entering it in field 46 or vote for the existing name by selecting radio button 48. If other names are proposed, radio buttons are displayed for those choices.

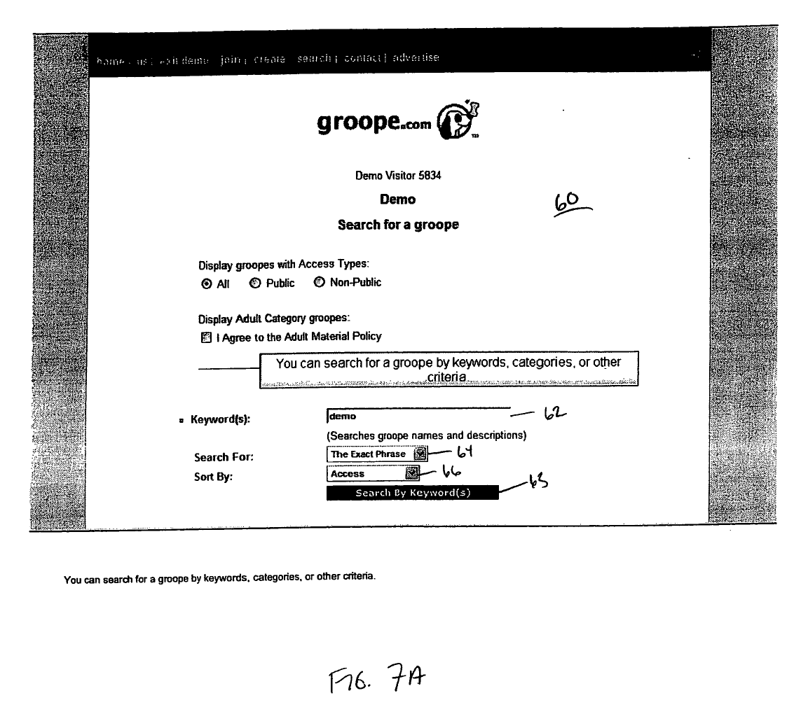

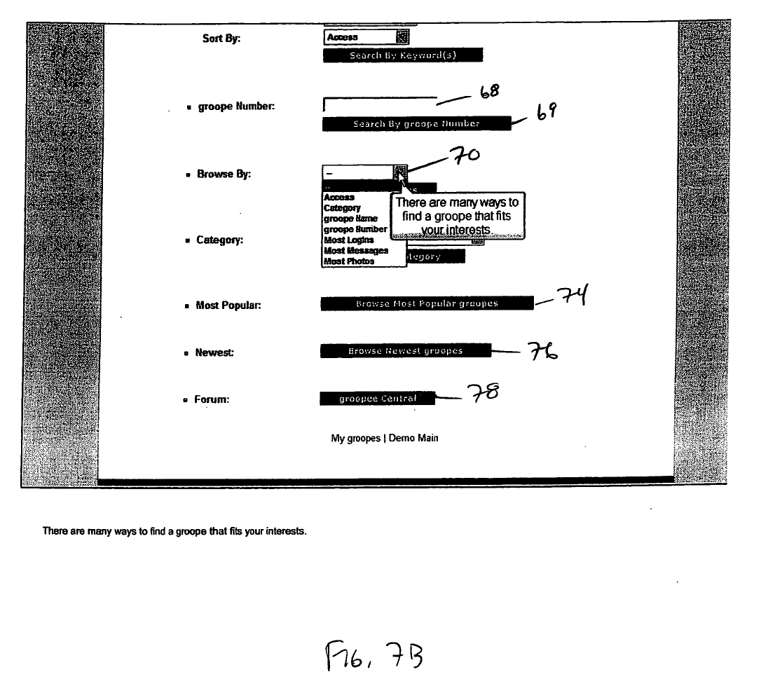

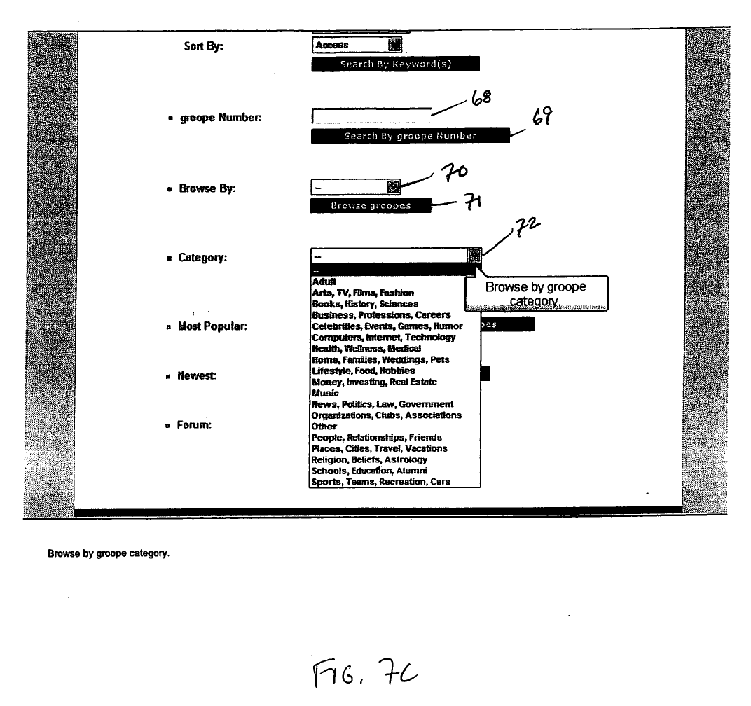

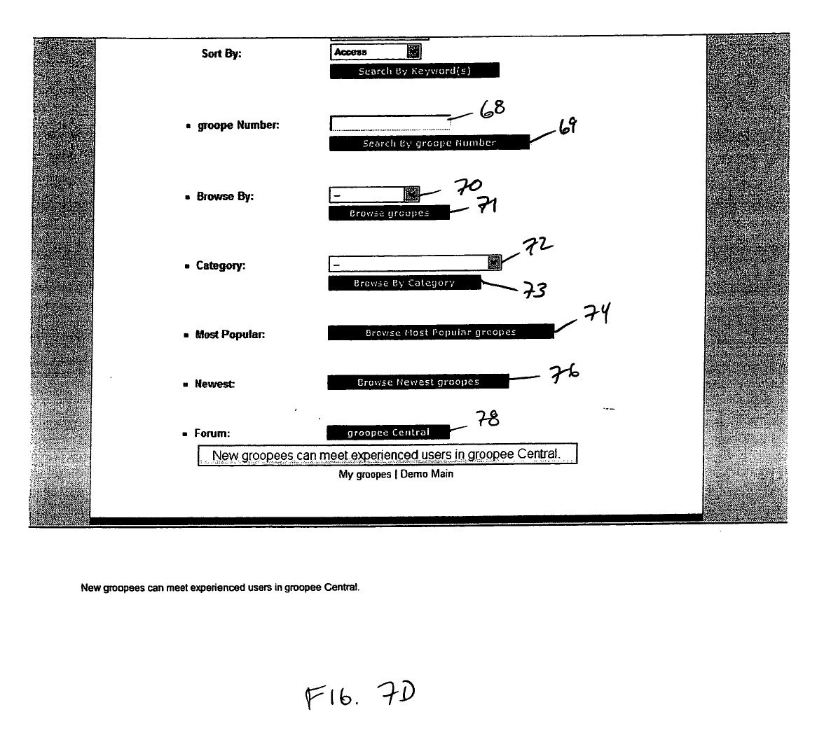

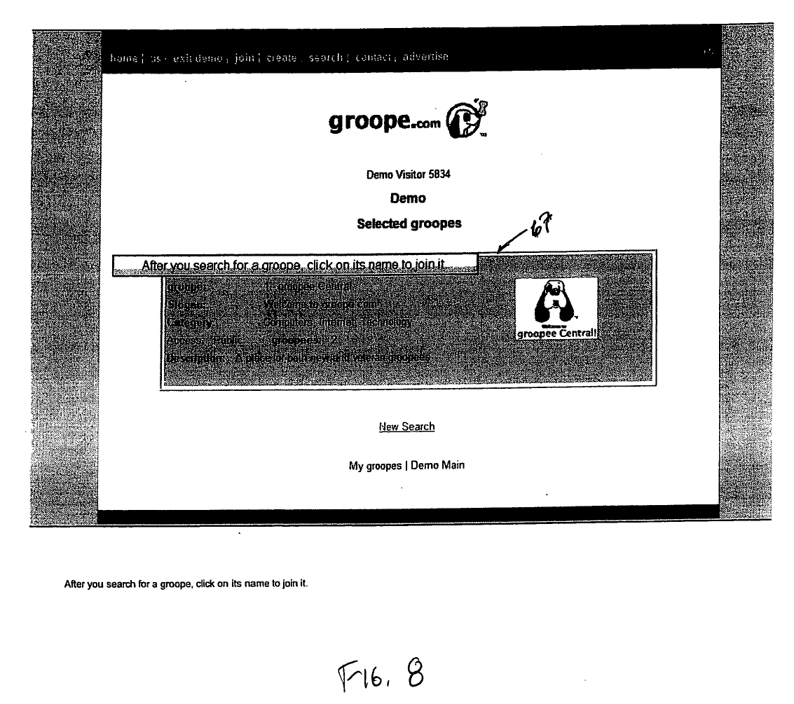

Referring to FIGS. 3A-3C, 7A-7D, and 8, a user can search existing groups by clicking on the search link 50 on home page 10 to reach search page 60. There, one or more search parameters are used. For example, group names and descriptions can be searched by entering keywords in field 62 and clicking button 63. If desired, pull down 64 can narrow the search to exact or partial matches while pull down 66 determines how the results 67 will be sorted. In other examples, groups may be searched by entering a full or partial group number in field 68 and clicking button 69.

Alternatively, a user may browse for a group by several different criteria. A user selects how the groups will be browsed with pull down 70, such as by access level, category, group name, group number, most logins, most messages, or most pictures, and begins browsing by clicking button 71. A user can directly choose a category to browse with pull down 72 and button 73. Groups may also be browsed by those that are most popular or newest by clicking buttons 74 and 76, respectively. Finally, users may choose to navigate to an online forum by clicking button 78 in order to meet members of groups and learn more about what groups are available and converse with other users about the site.

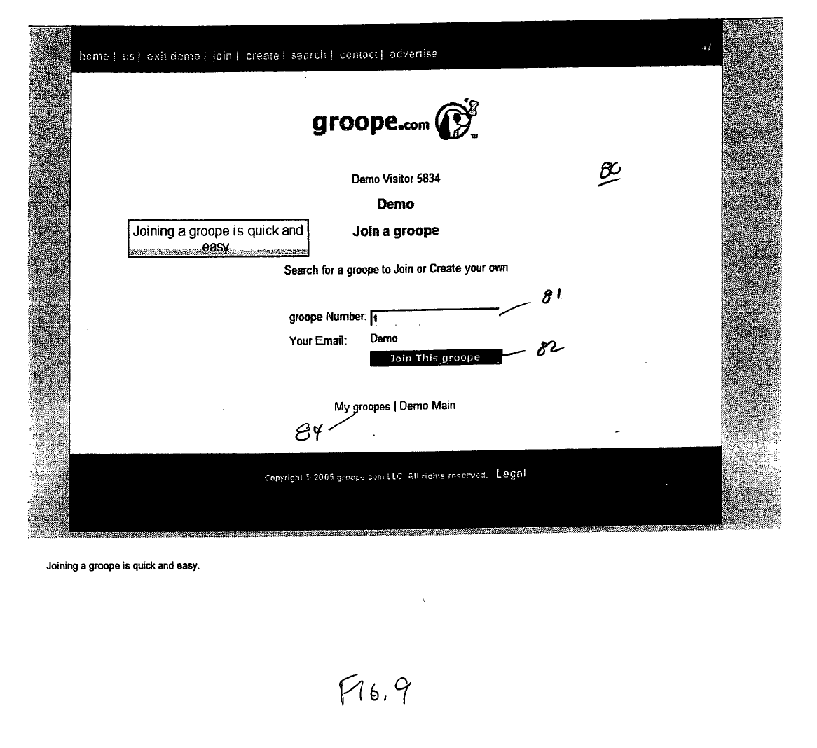

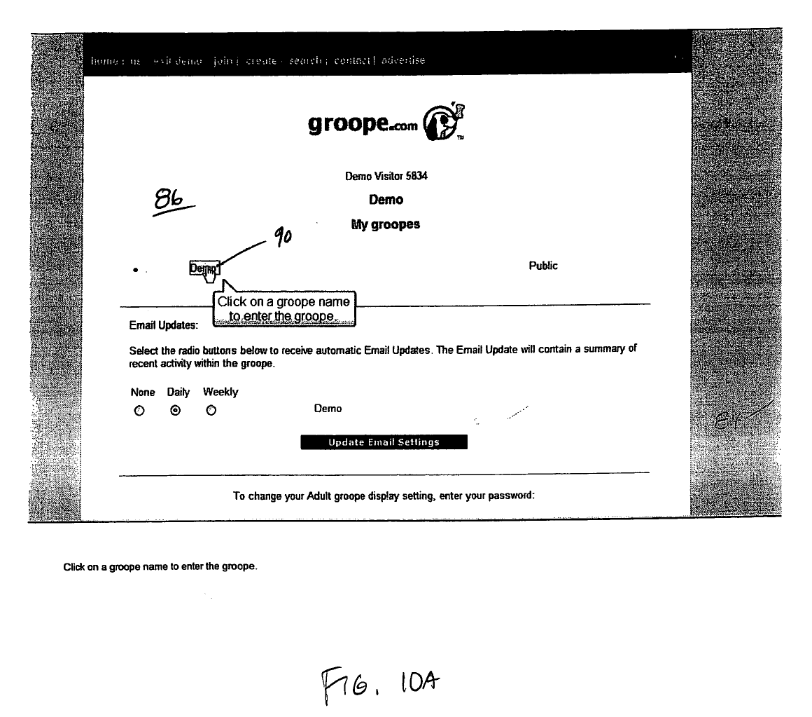

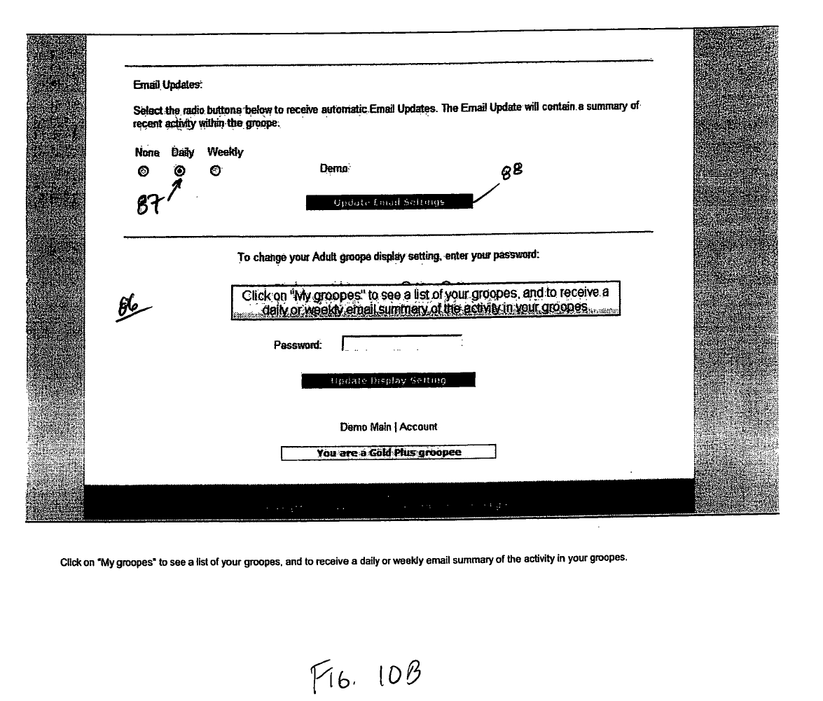

Referring to FIGS. 9 and 10A-10B, users can easily join existing groups. In one example, a user finds a group to join on page 80 by entering a group number in search field 81 and clicking on button 82. By clicking on link 84, a user can see a list of her groups on page 86. Using a set 86 of radio buttons and button 88, the user can choose whether and how often to receive summaries of the activity in the group. The user enters a group by clicking a link 90 from a list of links to her groups.

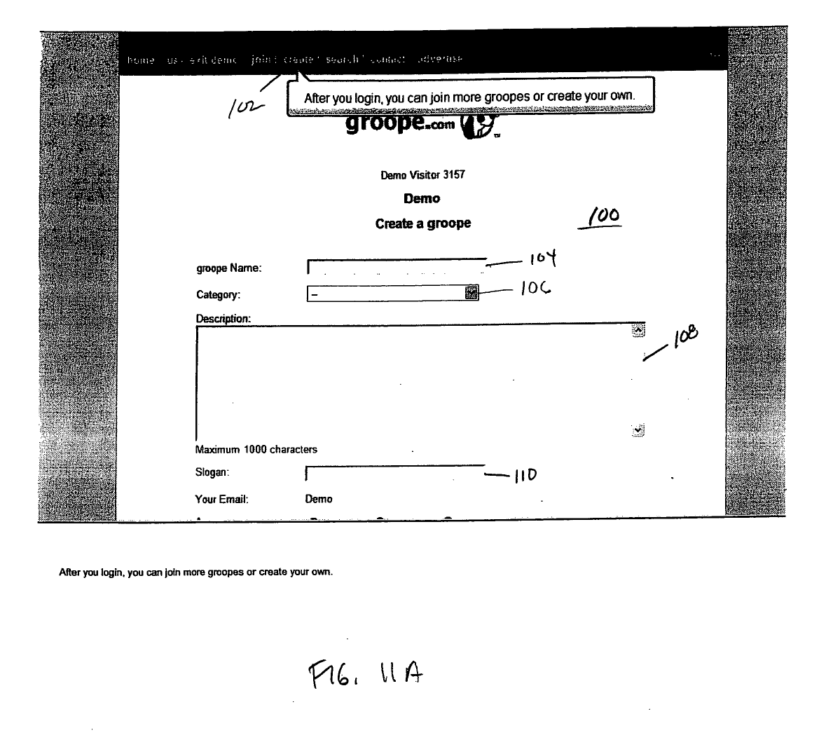

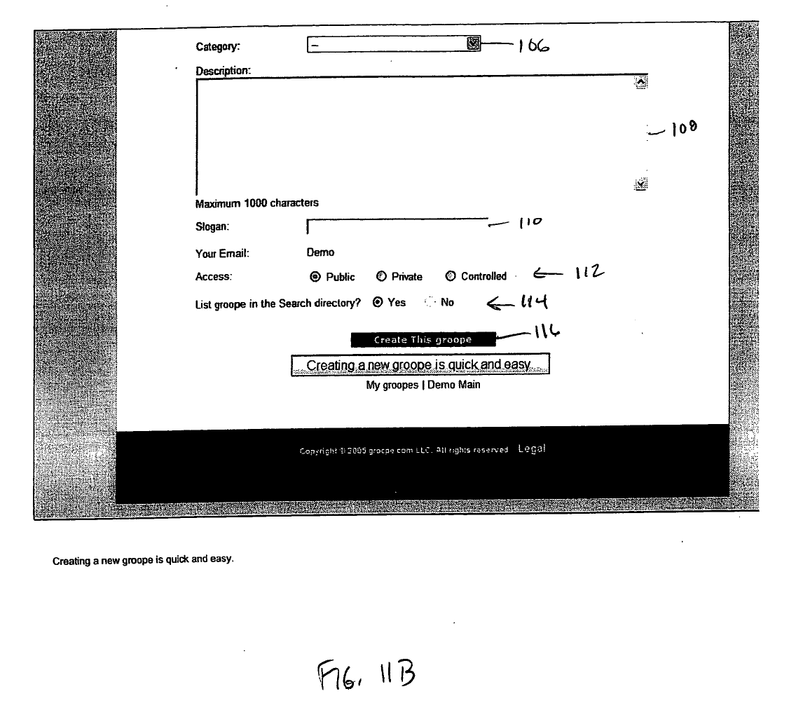

Referring to FIGS. 11A-11B, a user can create a group by navigating to page 100 using link 102. The group name is entered in field 104. A group category is chosen with pull down 106. A description may be entered in field 108. A slogan may be entered in field 110. The user can choose whether the new group will be public, private, or controlled with set 112 of radio buttons. As discussed above, if the group is public or private, group members later may change the other properties entered. The user has an option to list the group in a search directory by selecting from radio buttons 114 and creates the new group by clicking button 116.

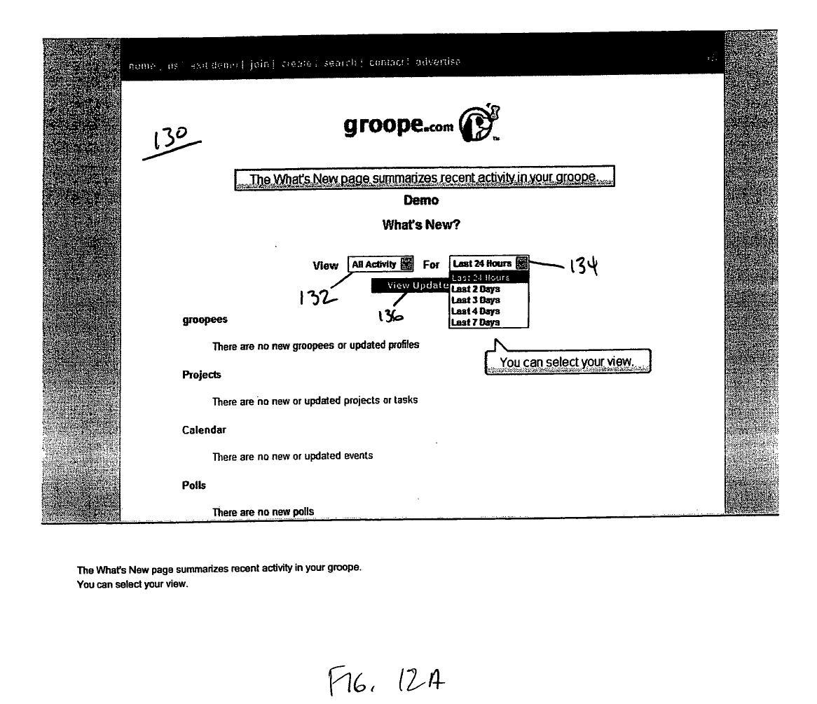

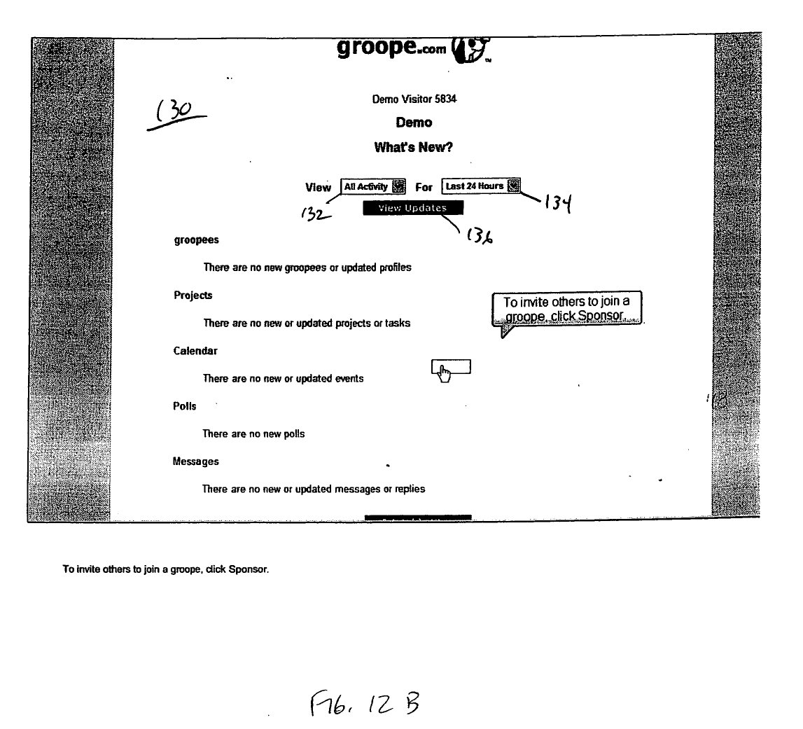

Referring to FIGS. 5F, 12A-12B, and 13A-13B, a group member can find out about recent activity in a group by clicking on the “What's New” link 118 at the bottom of page 30 to navigate to the “What's New” page 130. Using pull downs 132 and 134 and button 136, a user can select what kinds of recent activities to view and how recent the activities occurred. In one example, page 130 displays new group members or changes to existing group member profiles, new or updated projects or tasks, new or updated calendar events, new polls, or new or updated messages or replies. Users can elect to have daily or weekly emails sent to them for selected groups that list the recent activity in those groups during that time period. In other examples, the user may receive real-time updates of new activity through a syndication scheme. A particular example may be a Really Simple Syndication (RSS) feed from community accessed by a news reader on the user's computer.

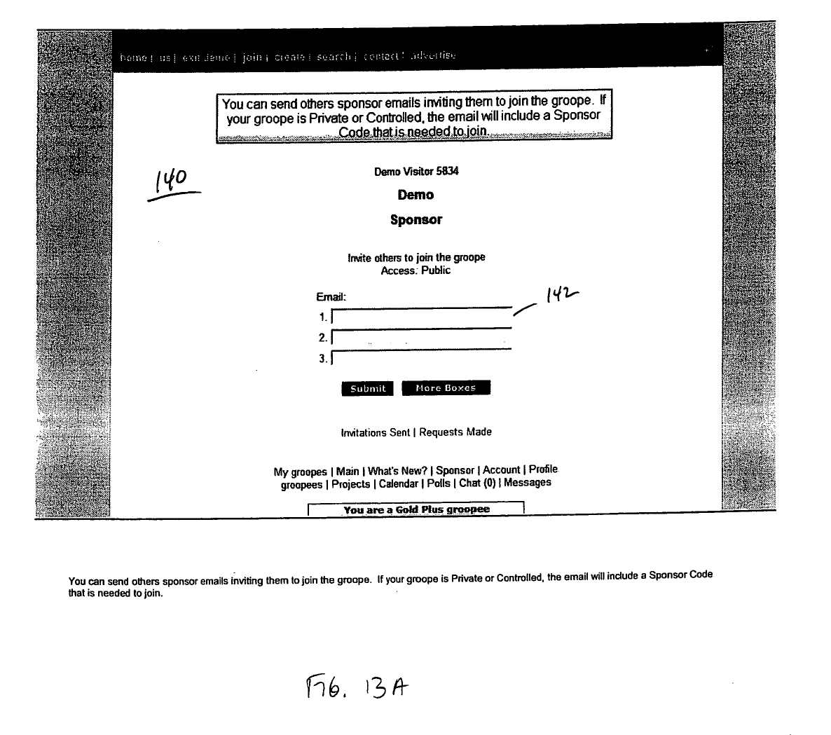

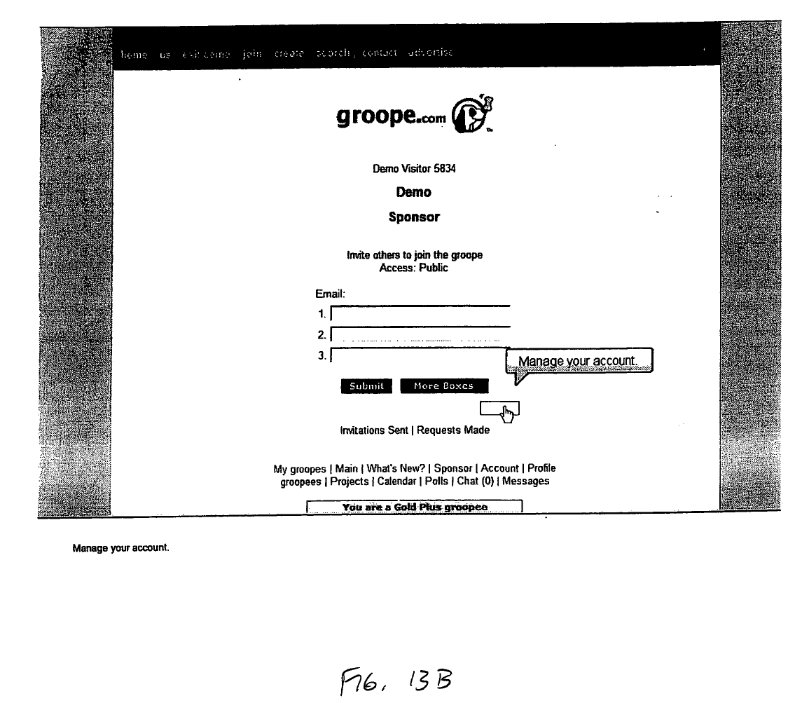

Referring to FIGS. 13A and 13B, a user can send other sponsor emails inviting them to join a group on “Sponsor” page 140. The user enters an email address in field 142 and an invitation is sent to that address. Additional fields may be added to page 140 to accommodate any number of invitations. If the group is private or controlled, the invitation will contain a sponsor code permitting membership in the group. Link 144 allows a member to see what invitations have been sent by the group. Link 146 allows a member to see requests for group membership by non-members.

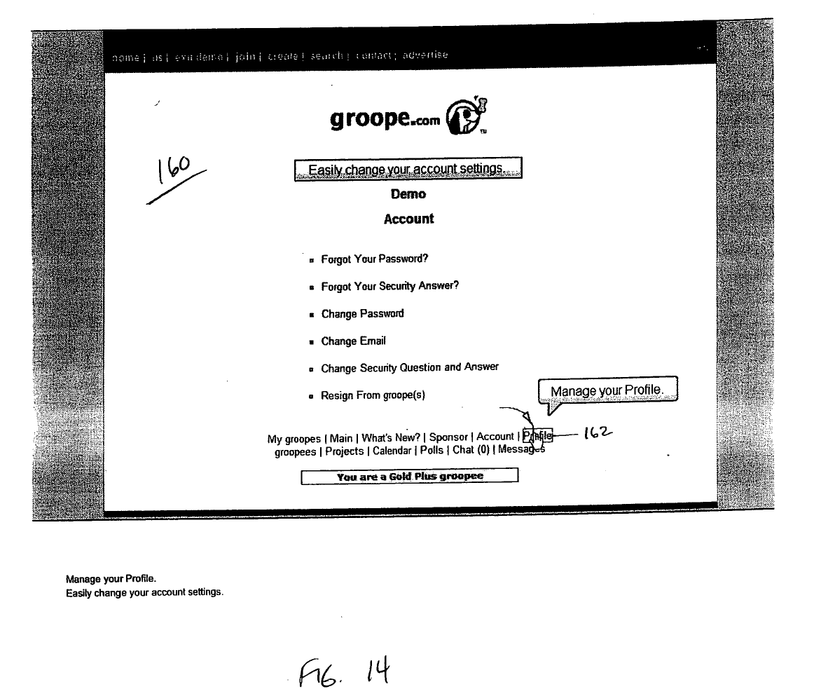

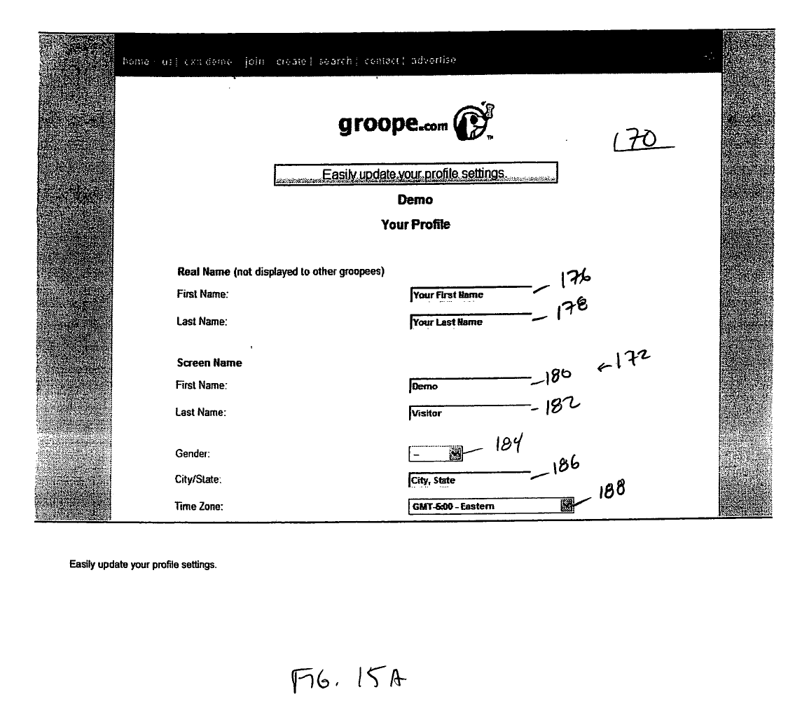

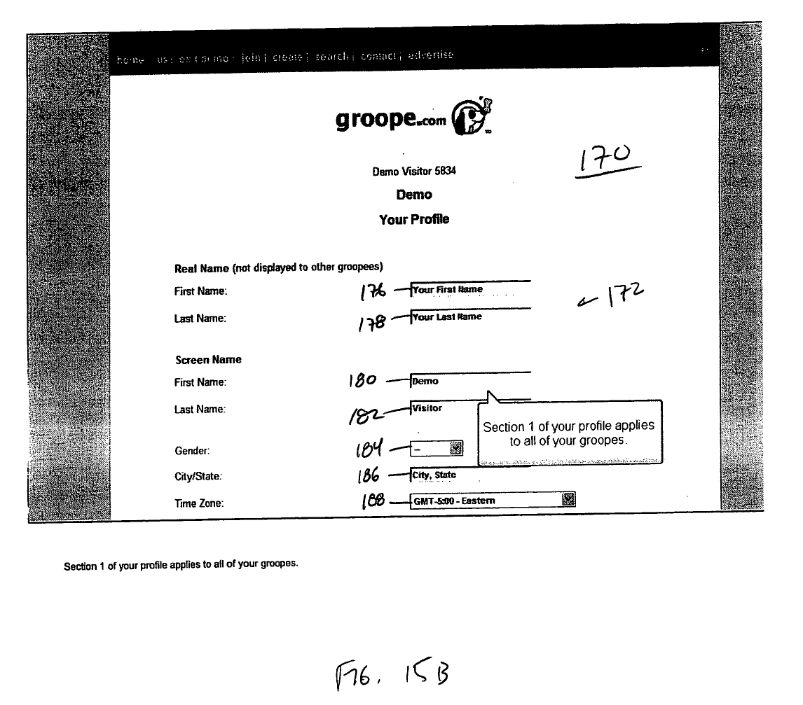

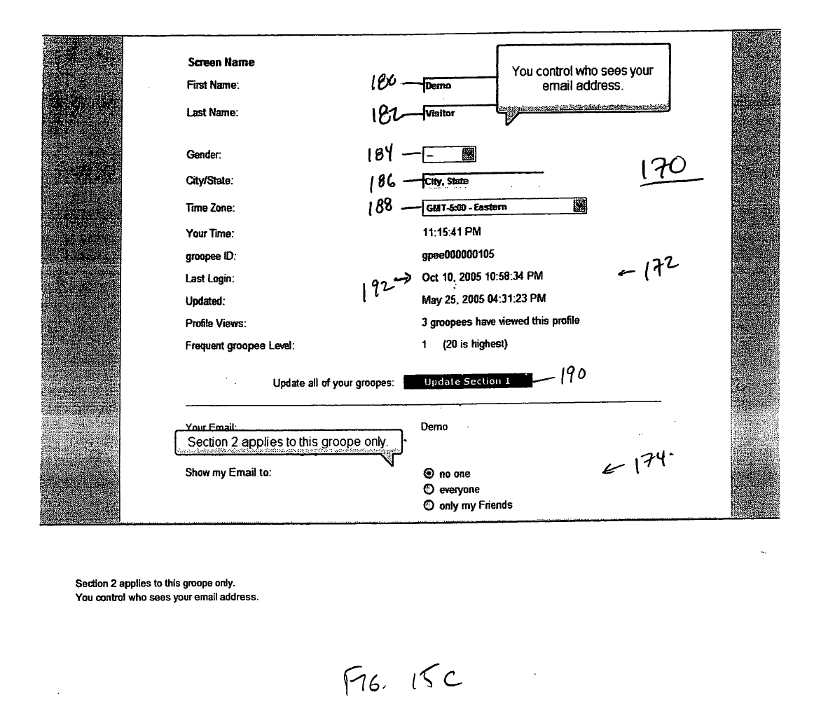

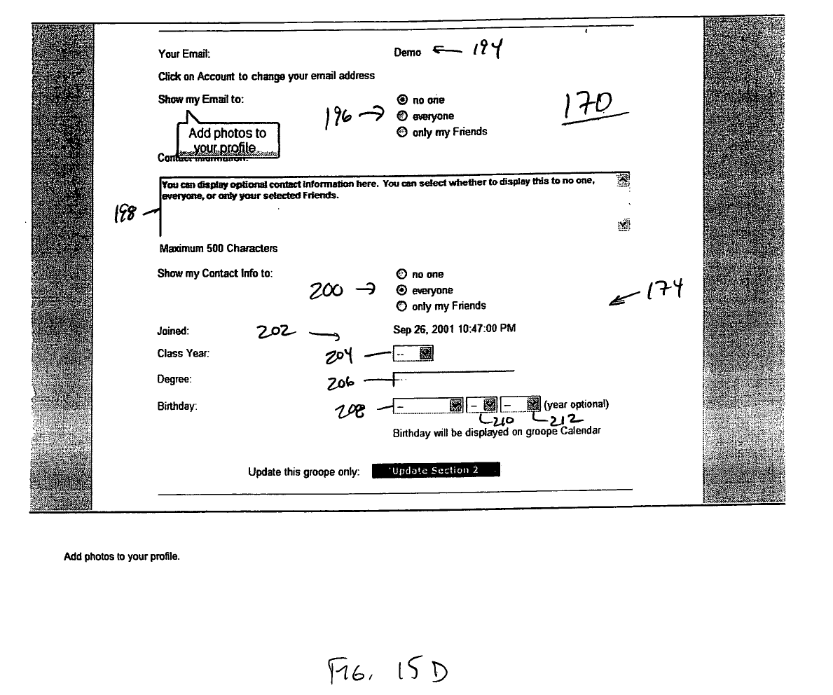

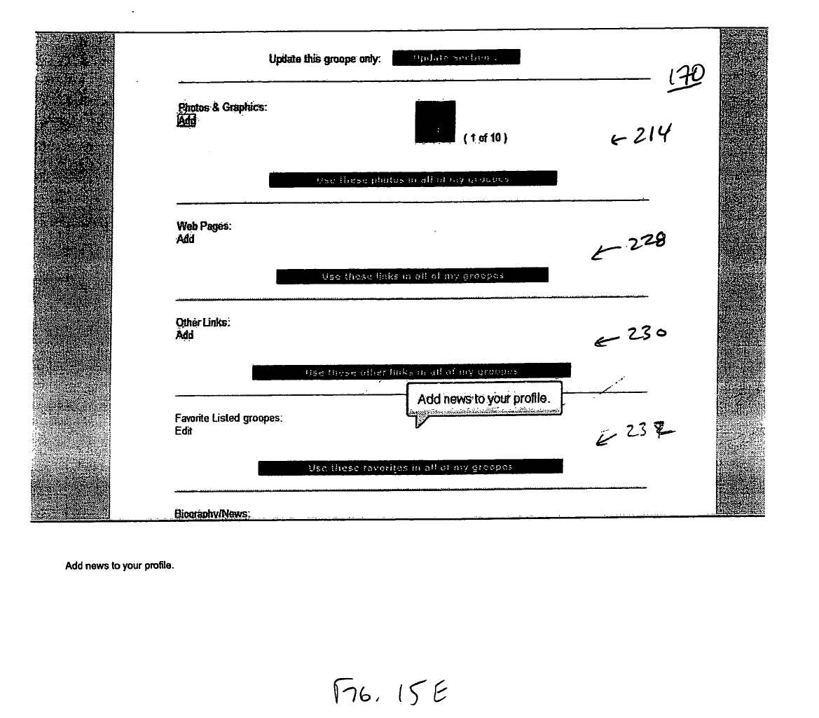

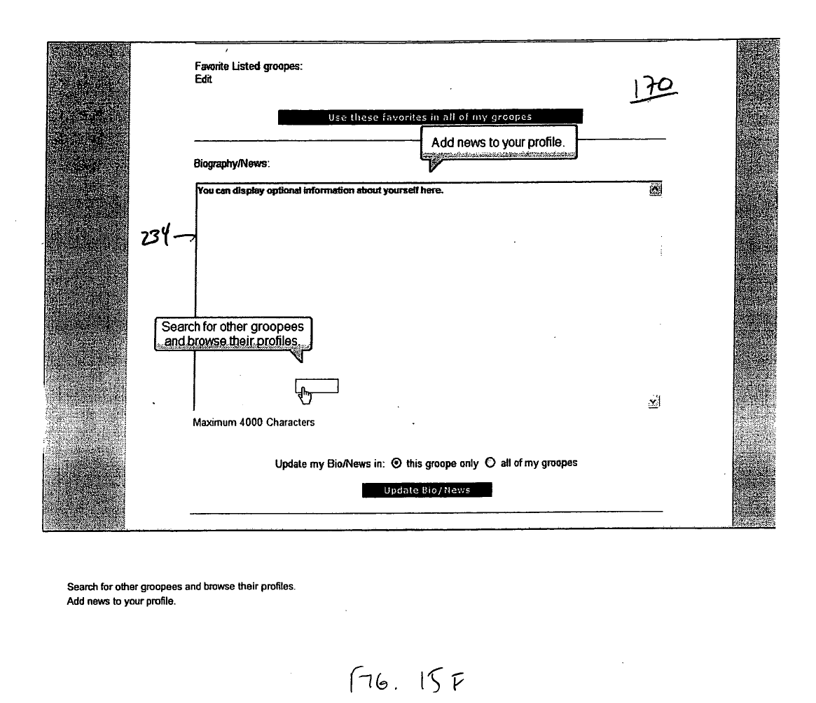

Referring to FIGS. 14 and 15A-15F, when a user joins a group, an account is created for the user. An example of an account is shown on Account page 160. Here, a user can manage her password, email, and security question or resign from a group. A user can also access her profile to manage how other group members perceive them and control what profile information is shared. Using link 162, the user can navigate to Profile page 170. Additionally, the user can navigate to page 170 from any page linked thereto.

A user's profile is split into two parts: part 172 remains consistent for all groups of which the user is a member, while part 174 may be customized for any group of which the user is a member. Profile part 172 includes fields for a user to enter her real first and last names (176, 178), the contents of which are not displayed to other group members, and fields to enter first and last screen names (180,182), which are displayed. Pull down 184 is used to select a gender, field 186 to enter a city and state, and 188 to select a time zone for the user. Information 192 about the user is also displayed in part 172, such as the user's local time, identification number, date and time of last login, date and time part 172 was last updated, number of times the profile has been viewed, and a member ranking number. The member ranking number is based on the frequency that the member uses the site relative to other members, informing others how experienced the user is and encouraging more frequent use of the site. The making may also be used as part of a member rewards program, for example.

Profile part 174 is displayed only in connection with an individual group. The user may modify part 174 so that the same or different information is displayed to each group of which she is a member. In one example, part 174 displays the member's email address at 194 according to which radio button she chooses from set 196. The user may enter additional contact information into field 198 and choose whom to show the information with set 200 of radio buttons. The user may choose to show her email address and other contact information to no one, everyone, or only to friends, as described in more detail below. The date the user joined the group is displayed at 202. The user may use pull down 204 and field 206 to display her year of graduation and degree received, respectively. Pull downs 208, 210, and 212 are used to choose the user's birthday, which will be displayed on the group calendar, as described in more detail below.

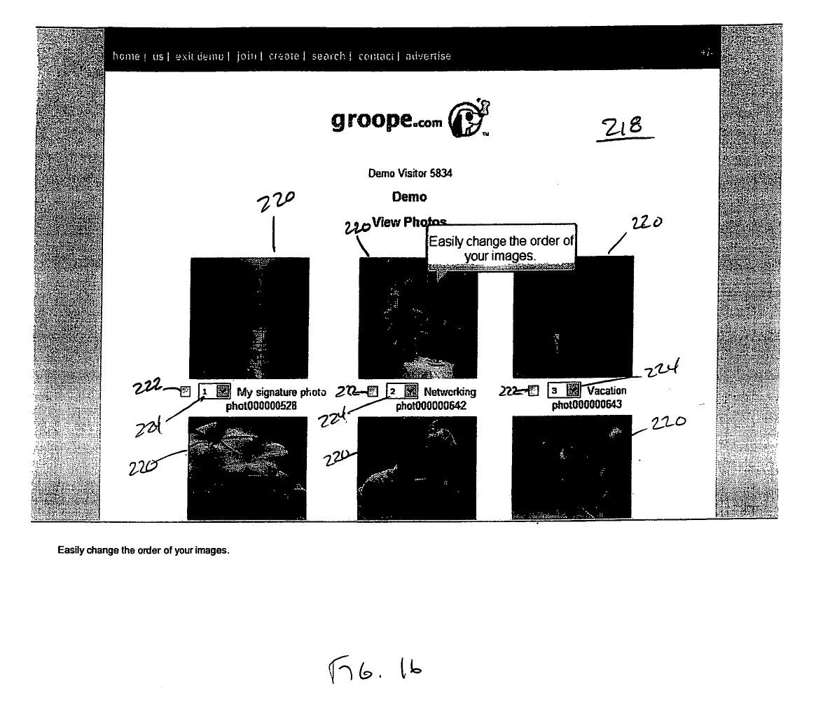

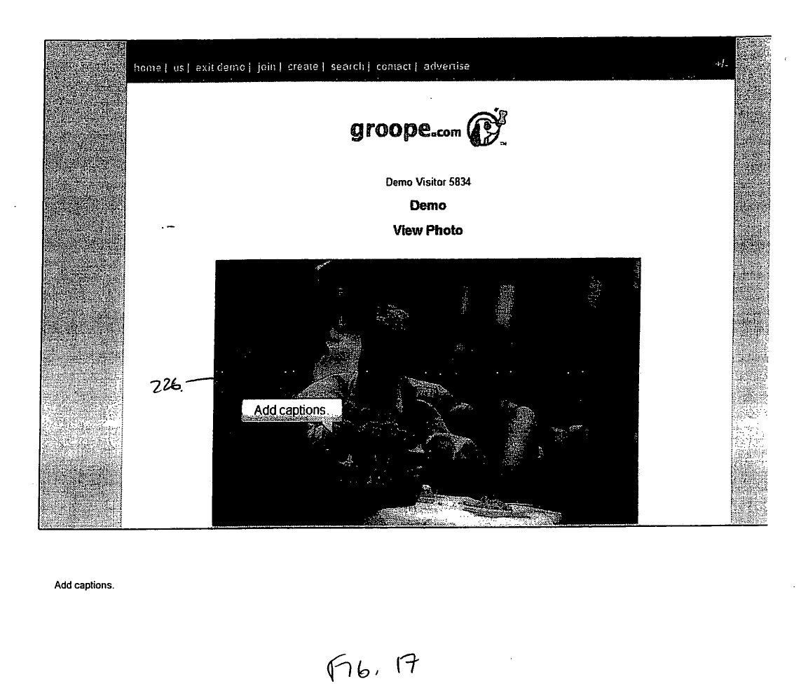

Referring to FIGS. 15E-15F and 16-17, profile page 170 displays additional information about the user. Photos and graphics uploaded to the user's account are displayed in profile part 214. The user may upload their own graphics or photos, or select images from the site's graphics and photo gallery. In one example, thumbnail views are displayed instead of full size images. Clicking link 216 takes the user to page 218 where photos 220 may be selected using check boxes 222 or arranged in order with pull downs 224 and captions may be added. Clicking on a thumbnail image takes the user to the full sized image 226 where a caption may be added.

A user's profile may also consist of collections of web page links in her profile at 228, other links at part 230 and favorite groups at part 232. Biography field 234 allows a user to display a biography or other news about her to an individual group or all groups of which she is a member.

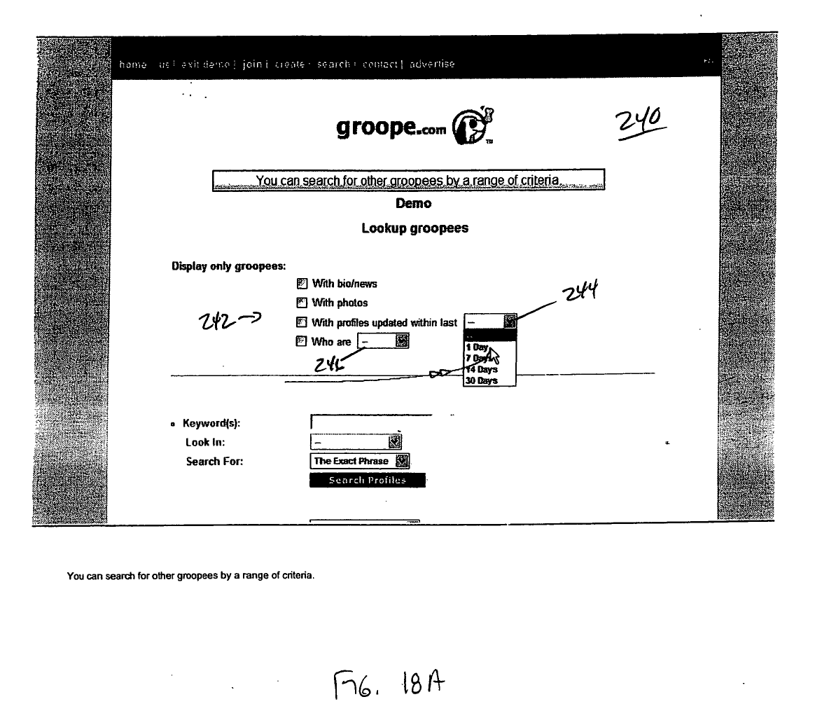

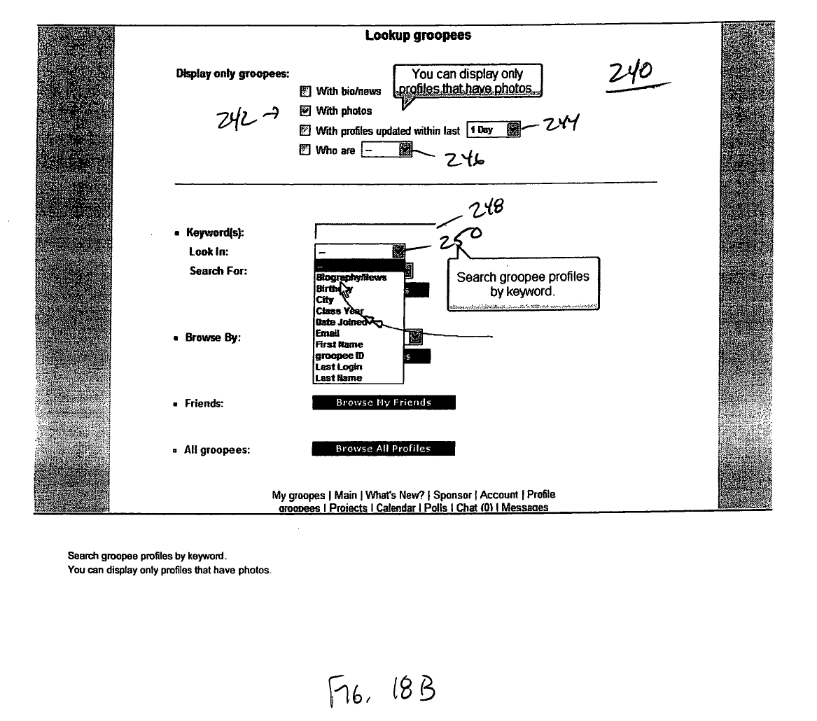

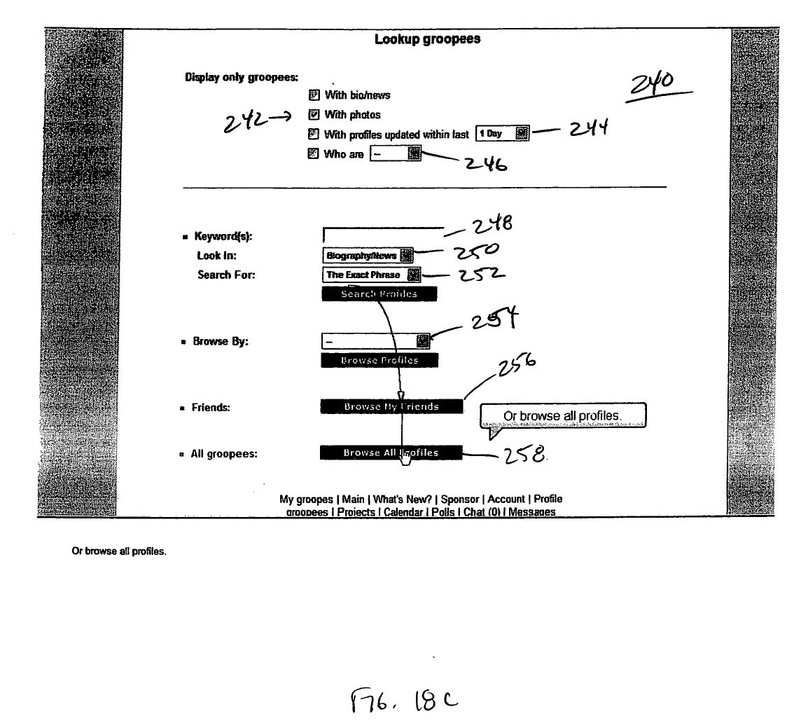

Referring to FIGS. 18A-18C, profiles are searchable by several different criteria on page 240. Using checkboxes 242, a user can choose to see profiles having bios/news, photos, recently updated profiles, or certain genders. Using pull down 244, the user can choose when to cut updates from the search. With pull down 246, the user can choose which gender for which to search. Profiles may be searched by keyword by entering the keyword(s) in field 248, choosing a profile field to search with pull down 250, and the degree of match to return with pull down 252. Alternatively, a user may browse profiles by choosing available criteria from pull down 254. Clicking button 256 browses profiles of the user's friends. Clicking button 258 may browse all profiles.

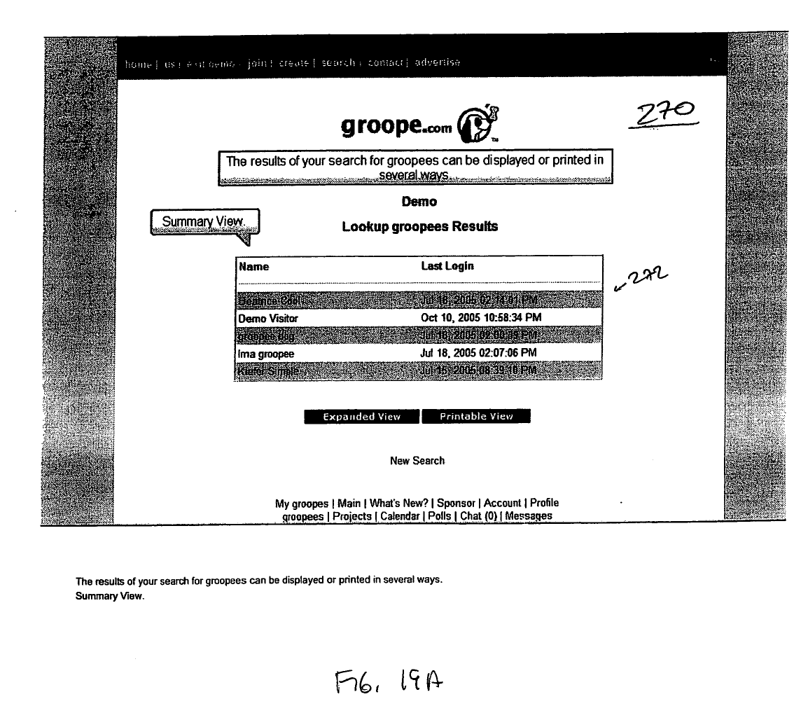

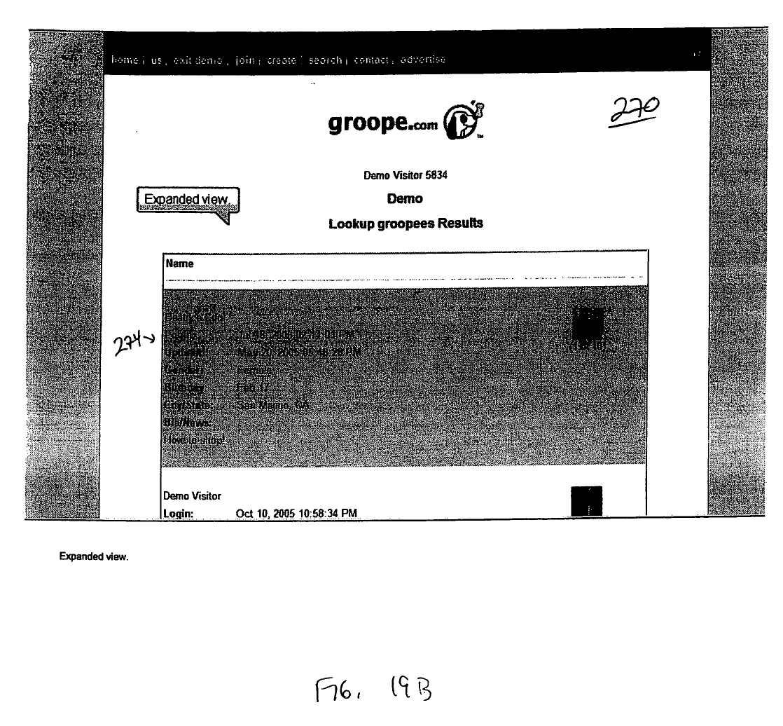

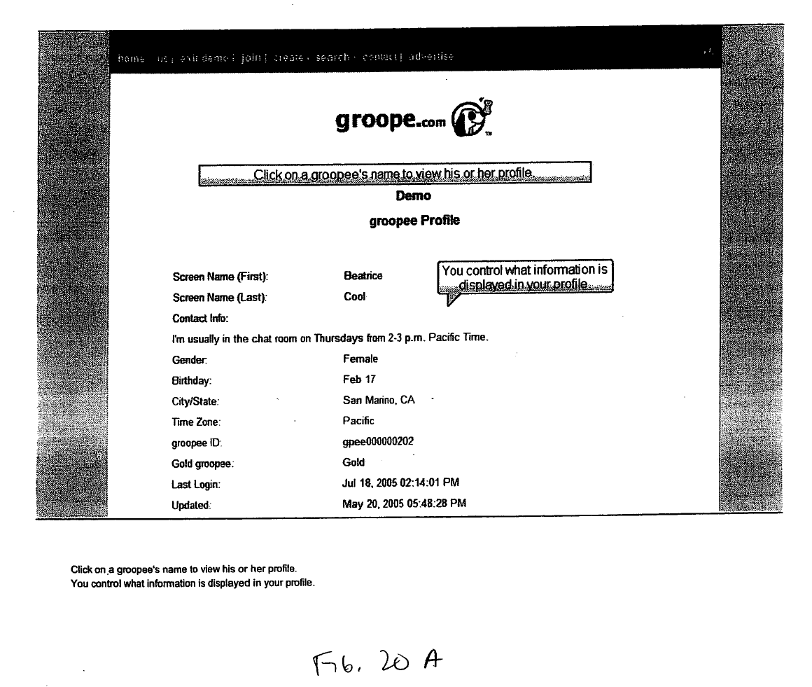

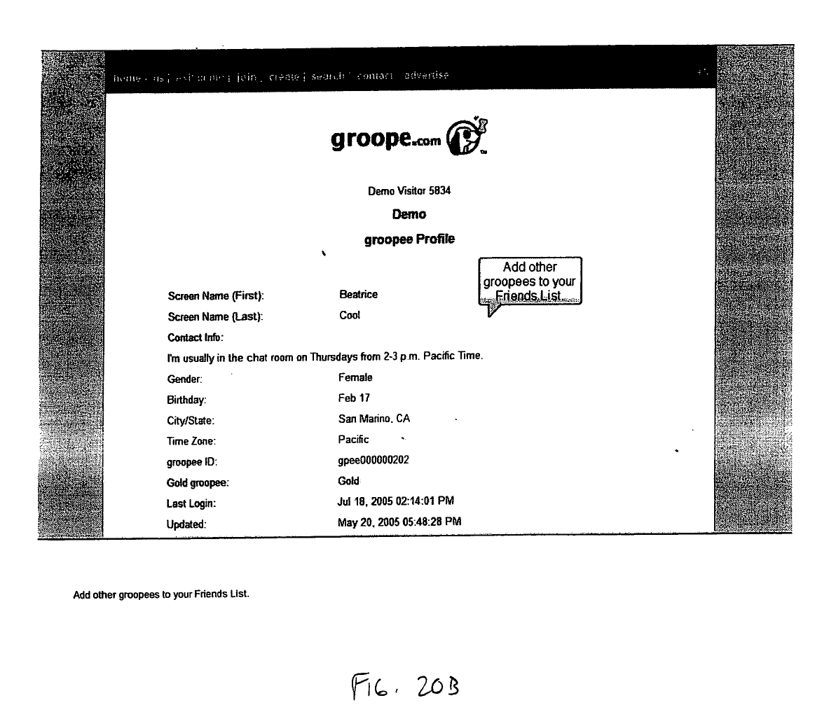

Referring to FIGS. 19A-19B and 20A-20B, results of a profile search are shown on page 270. In one example, the results are show in a summary view 272 that displays only the names of the profile found and the date and time of their last login. In other examples, the results are shown in an expanded view 274 that shows more information about each result, such as the date the profile was last updated, and the gender, birthday, city, state, and bio/news displayed in the profile. In some examples, a user's profile may be viewed by clicking on her screen name anywhere it appears. A group can work together on projects and manage those projects in one embodiment of the present invention. In one example, only users who subscribe for project management features are permitted to use project management tools.

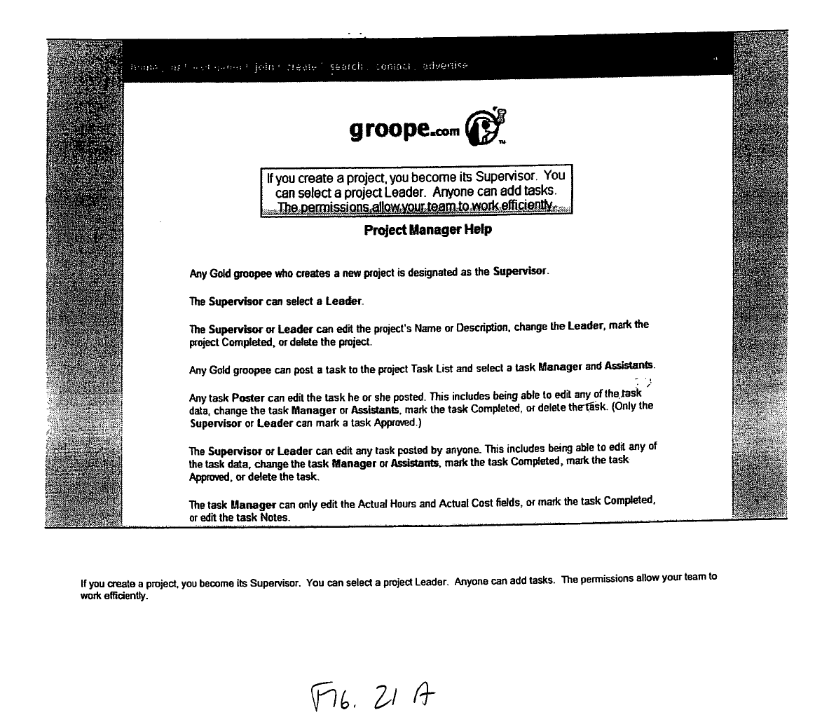

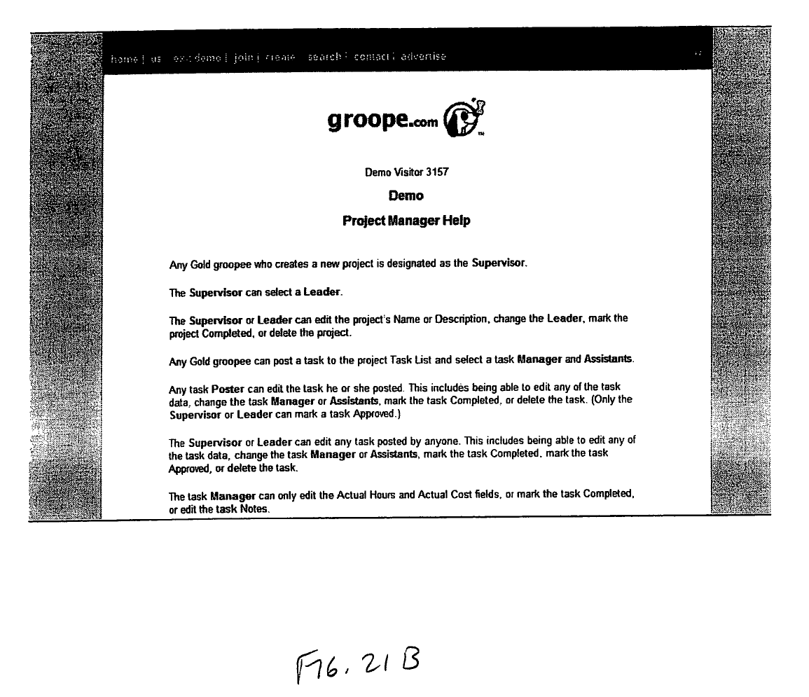

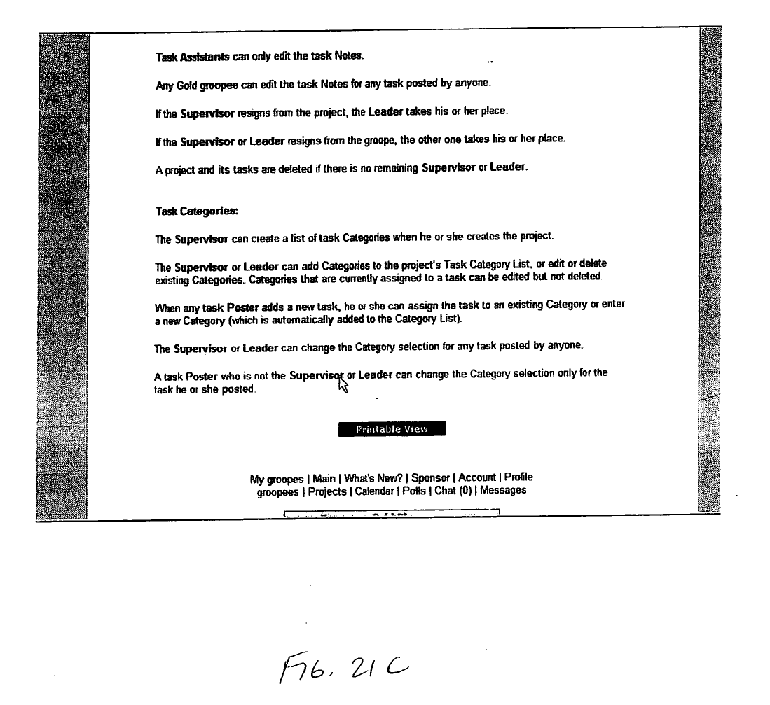

Referring to FIGS. 21A-21C, a brief overview of a project management system embodiment of the present invention will be helpful in describing embodiments in more detail. A user who creates a project becomes the supervisor of that project. The supervisor can select a project leader who is responsible for completing the project. The supervisor or leader can edit the project's name and description, change the leader, mark the project as complete, or delete the project.

Any project participant may post a task to the task list and select a task manager and assistants. Whoever posts the task may subsequently edit the task, including changing the task data, the manager, the assistants, marking the task completed, or deleting the task. Supervisors or leaders may edit tasks posted by anyone, in a manner similar to the poster of a task. The supervisor and leader may also approve tasks. The supervisor and leader may also flag a task for a member's attention. Users can click to view only flagged tasks on the task list. When users view the “What's New” page 130, receive an update email, or a syndicated update listing new activity, as discussed above, the user's flagged tasks will be indicated. A manager may edit the actual costs and actual hours of the task, mark the task completed, or add notes, but may not otherwise edit the task. Task assistants may only edit task notes. If the supervisor resigns from a project, the leader takes his place. If the supervisor or leader resigns from the group, either takes the other's place. Projects without a remaining supervisor or leader are automatically deleted.

The task data and status information for each task may be updated on a task data page where all task details are shown. In addition, the supervisor and leader may mark selected tasks completed or approved, or extend due dates, with a single click.

Supervisors may also create task categories when she creates the project. Both the supervisor and leader may add, delete, or edit categories. Categories having tasks assigned to them, however, may only be edited. When any task poster adds a new task, she can assign the task to an existing category or enter a new category, which is added to the category list. The supervisor or leader may change the category of any posted task while the task poster may only change the category of her own-posted tasks.

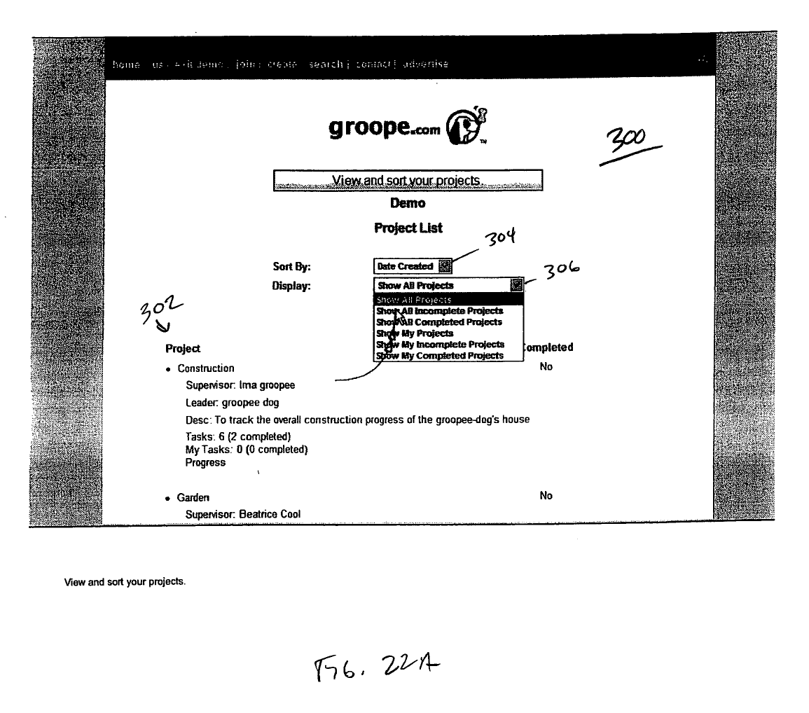

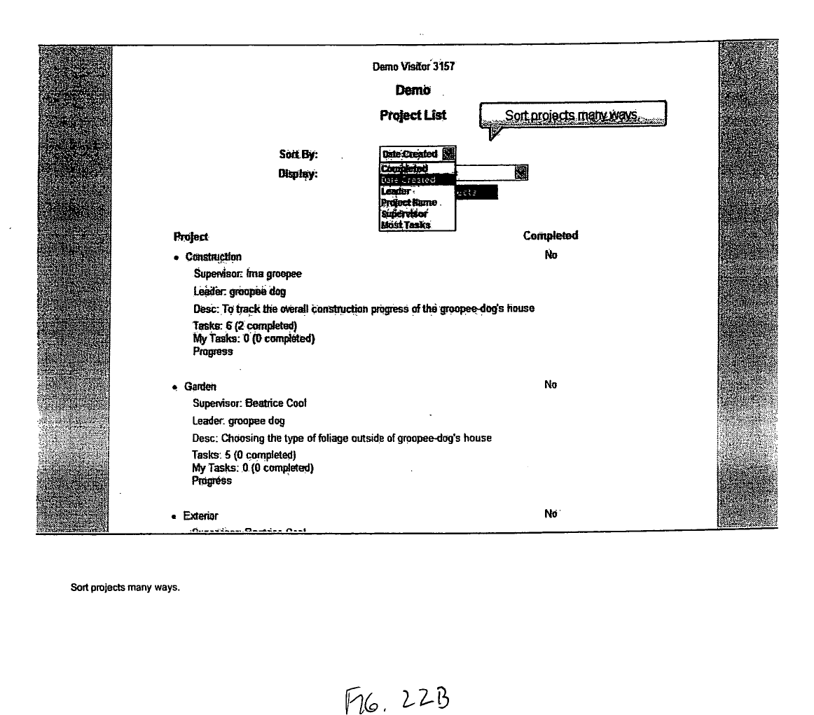

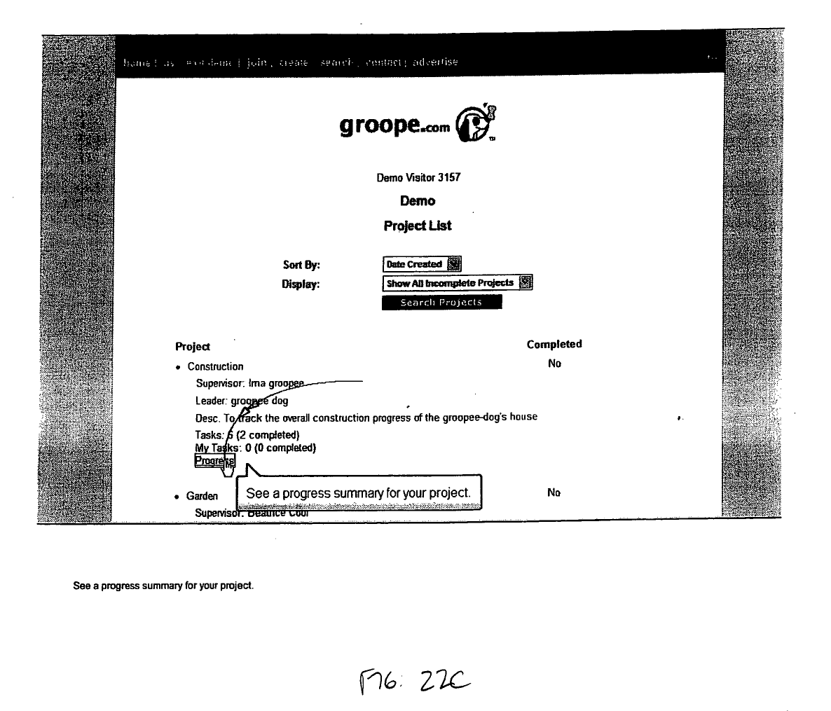

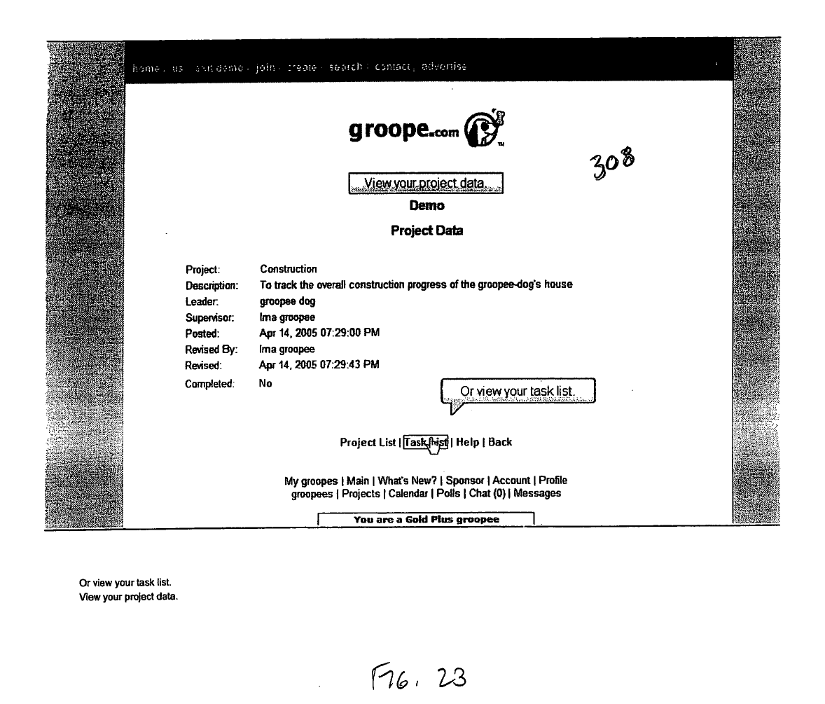

Referring to FIGS. 22A-22C and 23, Project list page 300 shows a list 302 of projects in which the group is involved. The projects may be ongoing or completed. Pull down boxes 304 and 306 are used to easily customize the listed projects. In one example, the projects may be sorted by the dates they were created. In another example, all completed projects are shown. In other examples, all projects, all incomplete projects, all the user's projects, or all the user's completed or incomplete projects may be shown. The project list shows summary data for each project listed, such as the project name, supervisor, leader, description, and task information. Data for individual projects may also be displayed, such as on page 308, for example.

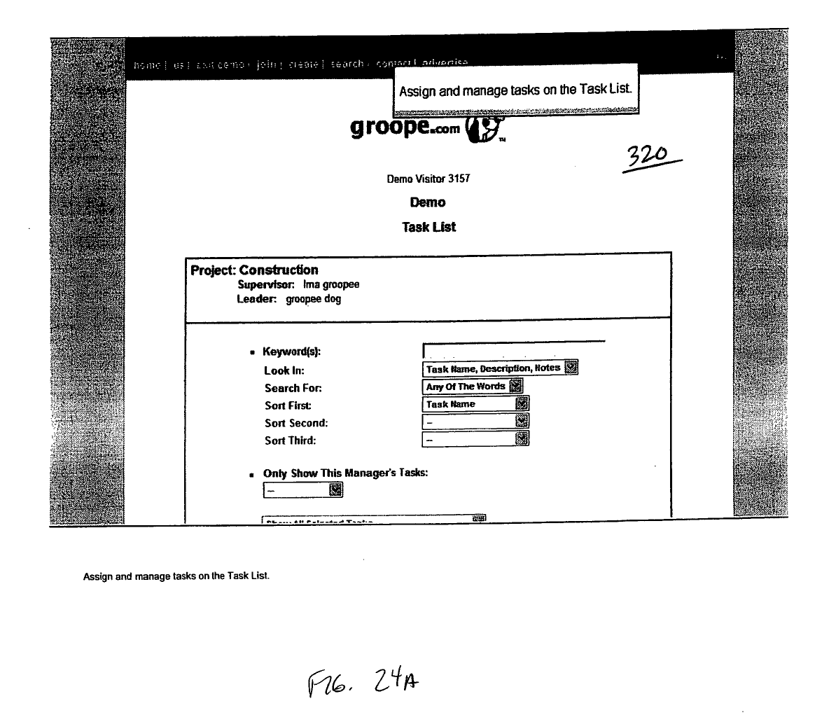

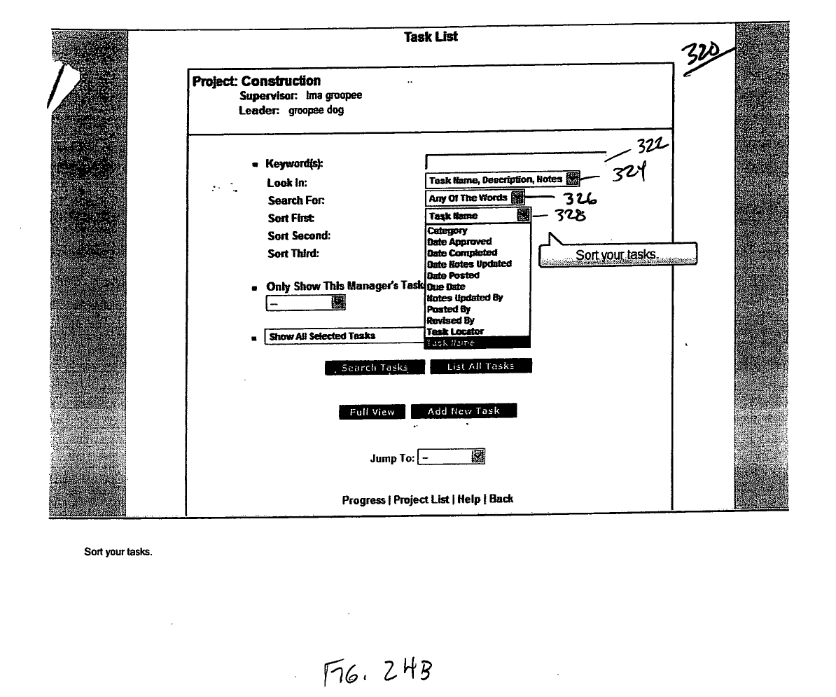

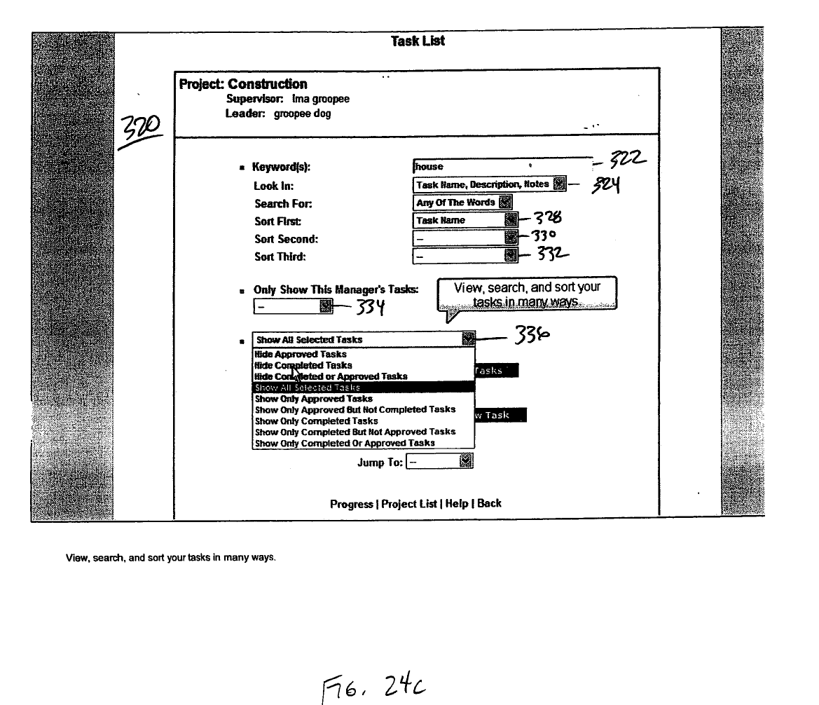

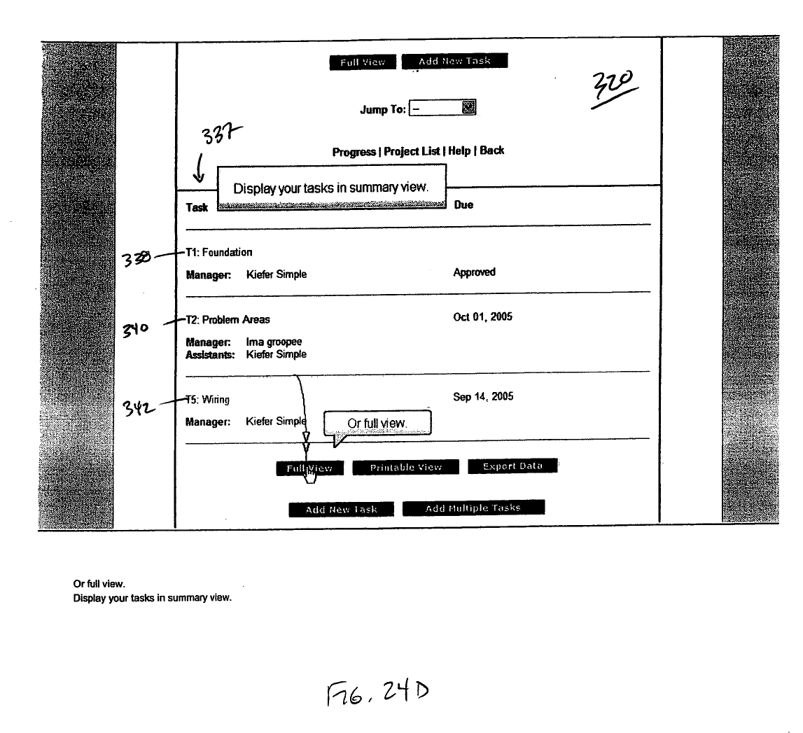

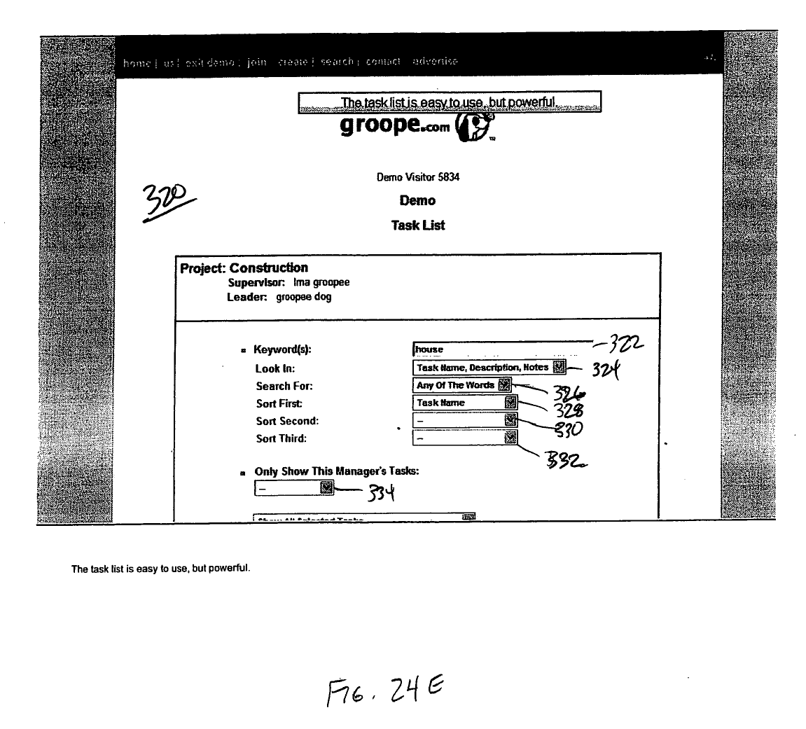

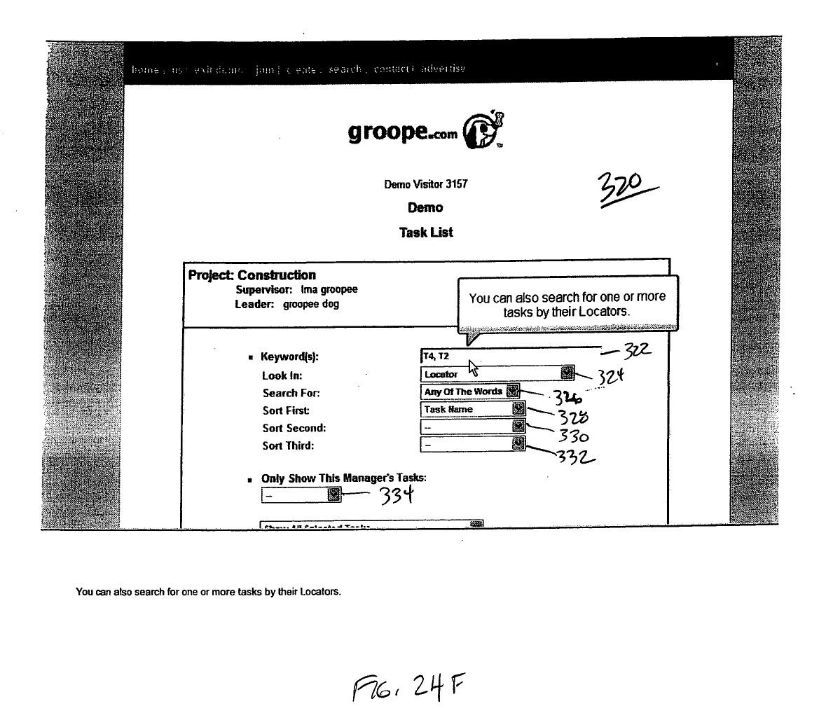

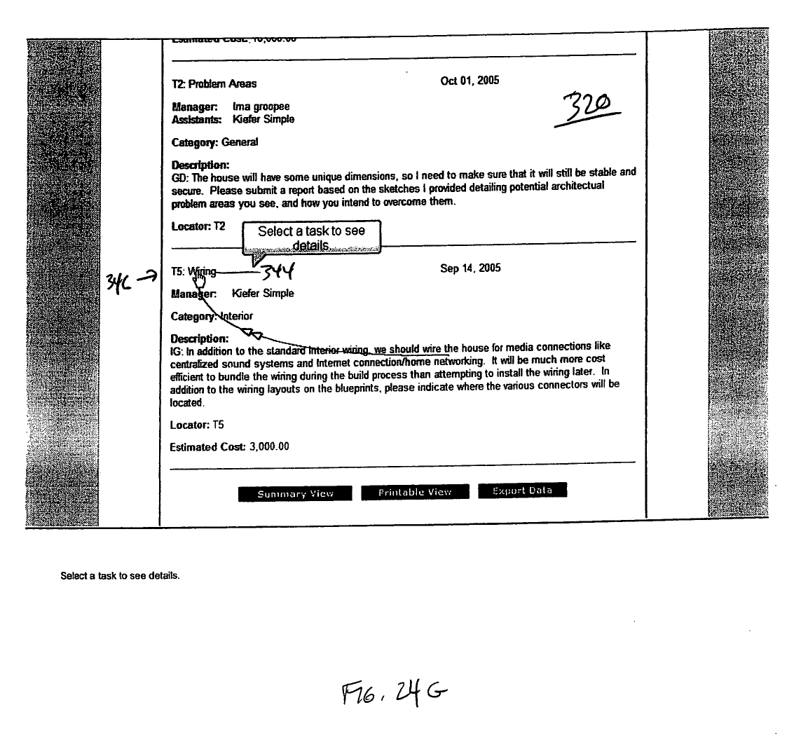

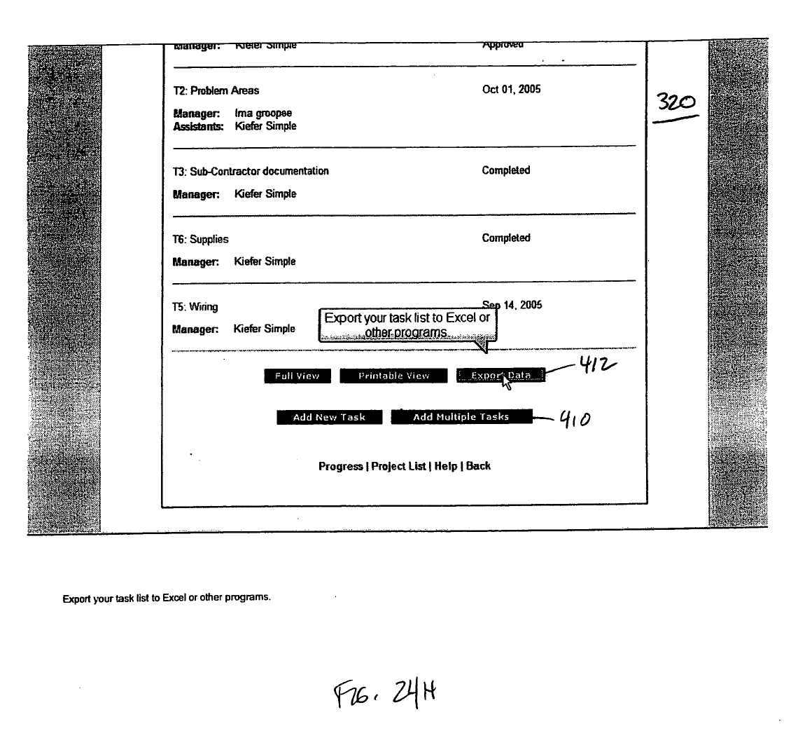

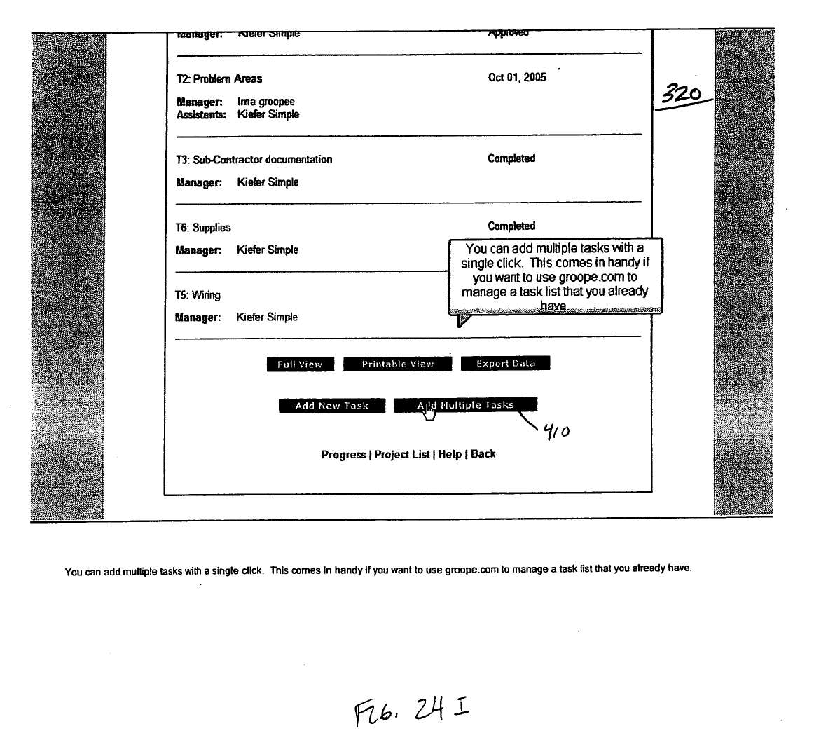

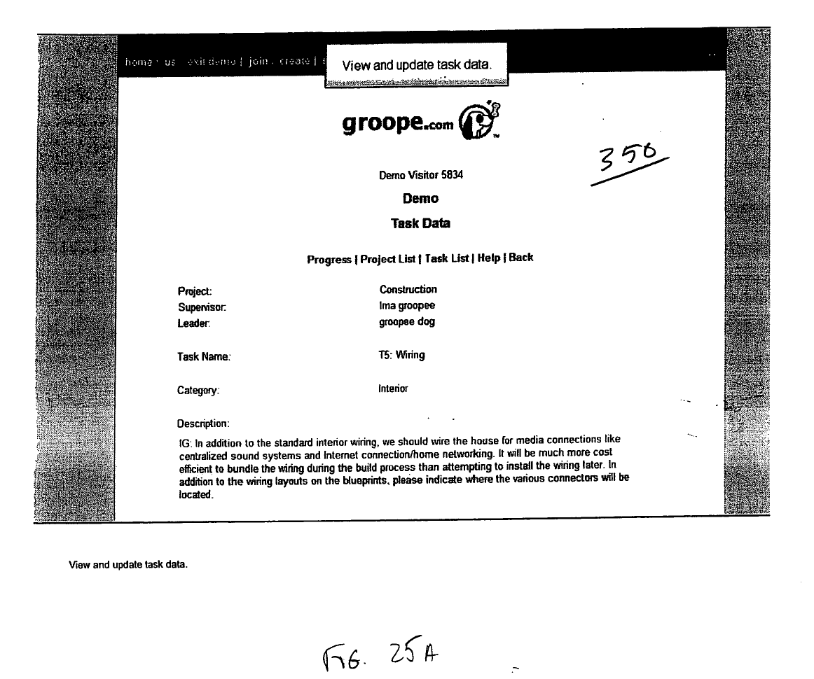

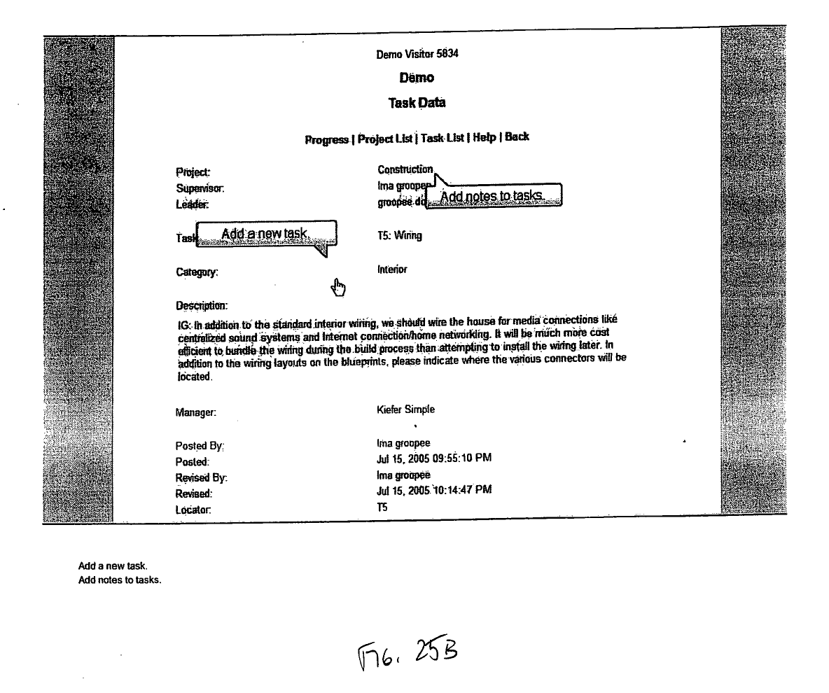

Referring to FIGS. 24A-24I, a task list also helps group members manage projects. Each project contains an interactive task list. Task list page 320 allows a user to display a list of tasks by many different criteria, which allows great flexibility and ease of use. Tasks can be searched by keyword(s) entered in field 322. Tasks can also be searched by one or more identification numbers (“locators”) entered in field 322 as each task is assigned a unique locator. Pull downs 324 and 326 determine what task data will be searched and how precise a match is required, respectively. Pull downs 328,330, and 332 sort the resulting task list by criteria such as task name, category, date approved, date completed, date notes updated, date posted, due date, notes updated by, posted by, revised by, task locator, or task name. A manager, using pull down 334, can also display tasks. Other criteria may be used to sort and display tasks using pull down 336, such as whether the tasks are approved, selected, or completed. In this way, the task list may be quickly and easily sorted in ways that help the user.

Tasks list 337 shows tasks 338, 340, and 342 in a summary view. For each task, the name, manager, and due date of the task is shown. If one or more assistants have been assigned to the task, or if the task has been flagged for a user's attention, they may be displayed in the summary view as well. The summary view also displays the task locator and if the task was completed or approved.

The task list may also be displayed in full view. Full view displays a list of all selected tasks and detailed information for each task on the list, including all of the information displayed in summary view plus the task category, description, notes, and estimated and actual time and hours.

Referring to FIGS. 24A-24B, each task may be selected to see a detailed view of the task details. For example, clicking link 342 in task 344 can navigate the user to task data page 350, which displays the project name, supervisor, leader, task name, task category, and a description of the task, for example. In other examples, a user could add notes to the task from page 350. In still other example, page 350 could include a history logs for estimated and actual task hours and estimated and actual task costs for the individual task. The log could show the value, date, and person making the update to the task data.

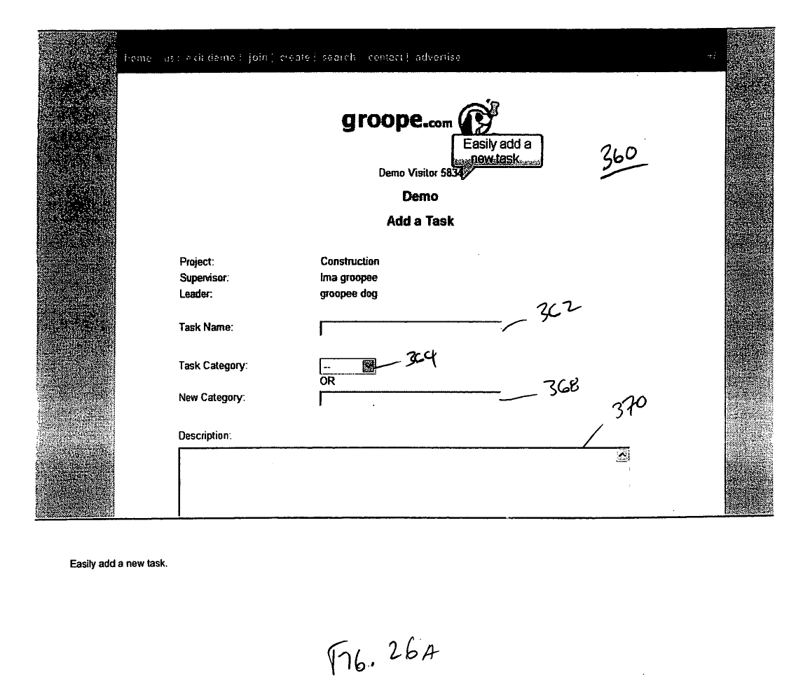

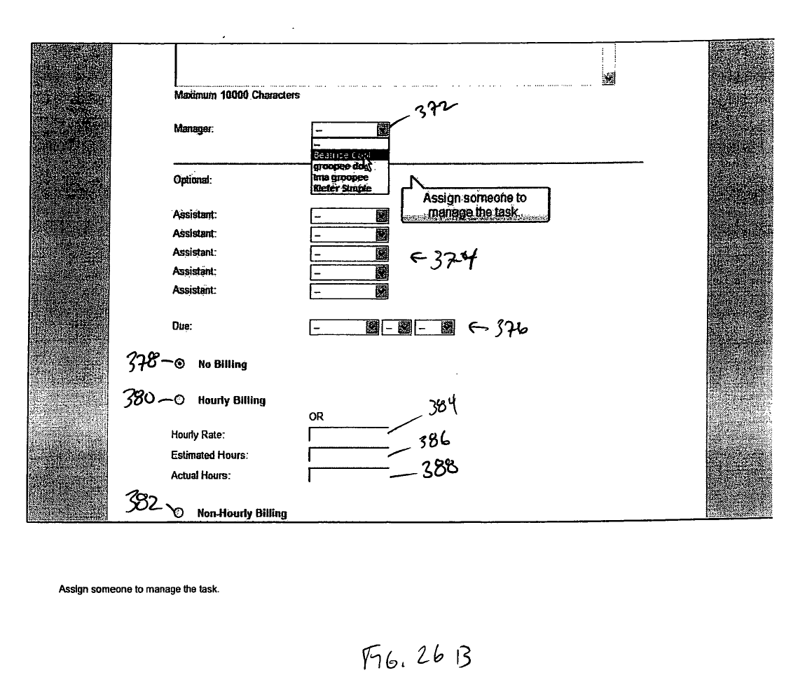

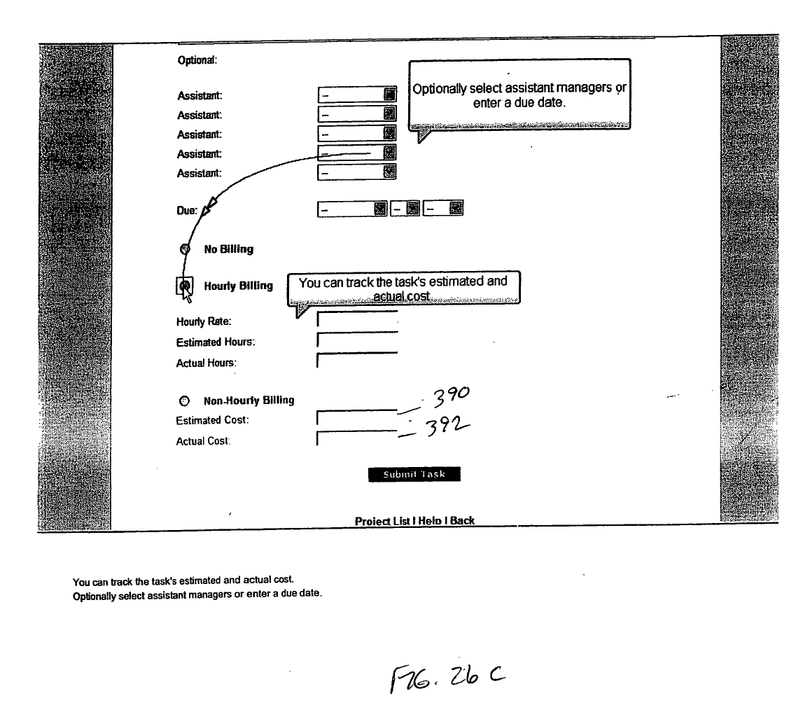

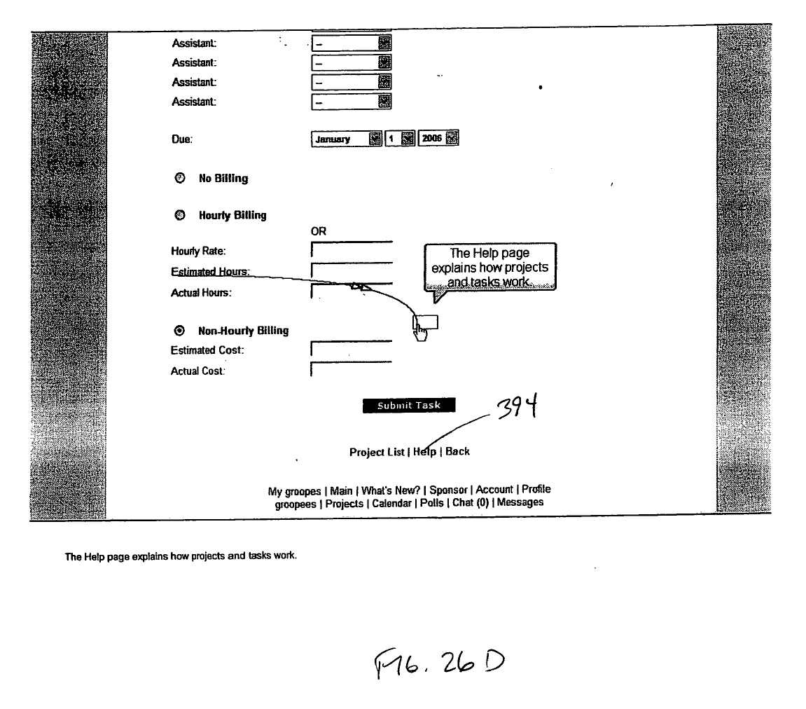

Referring to FIGS. 26A-26D, a task can be added to a project on page 360. The user enters the task name in field 362, either chooses an existing task category from pull down 364 or enters a new task category in field 368, and adds a description of the task in field 370. Finally, the manager is chosen using pull down 372.

Additional task data may also be entered when the task is created. One or more assistants may be chosen using pull down 374. The task may also be flagged for a user's attention. Pull down 376 assigns a due date to the task. Radio buttons 378, 380, and 382 control whether the task is subject to no billing, hourly billing, or non-hourly billing, respectively. If the task is subject to hourly billing, an hourly rate and estimated hours are entered in fields 384 and 386. The hourly rate can be selected from a pull down list of hourly rates entered for previous tasks, or a new hourly rate can be entered. As hours are spent working on the task, a running total is entered in field 388. If the task is subject to non-hourly billing, an estimated cost is entered in field 390. When the task is completed, the actual cost is entered in field 392. A project management help page 394 can be accessed from help link 392 at the bottom of page 360. In another example, supervisors or leaders can click to copy or move existing tasks to other projects for which they are also the supervisor or leader.

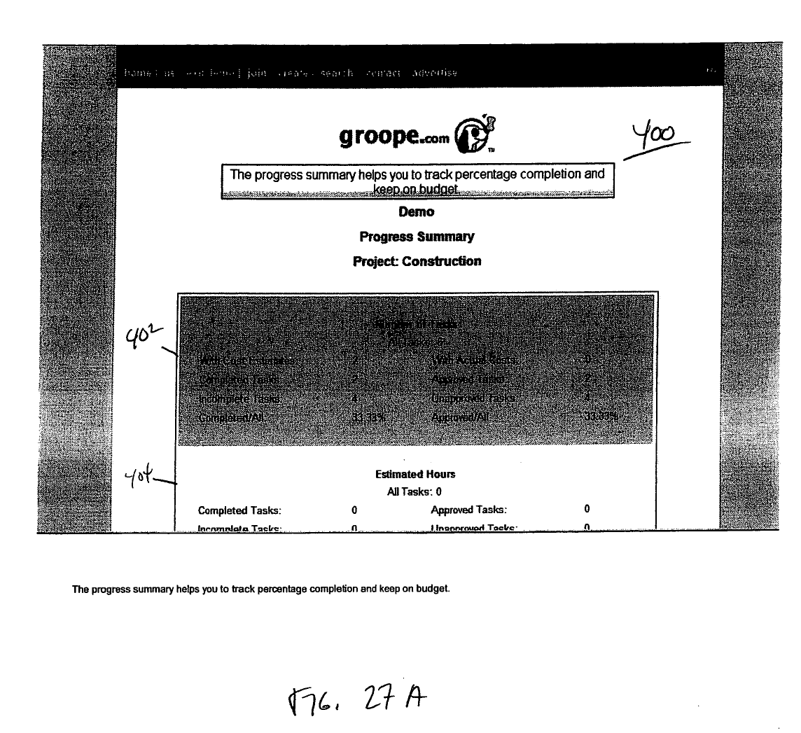

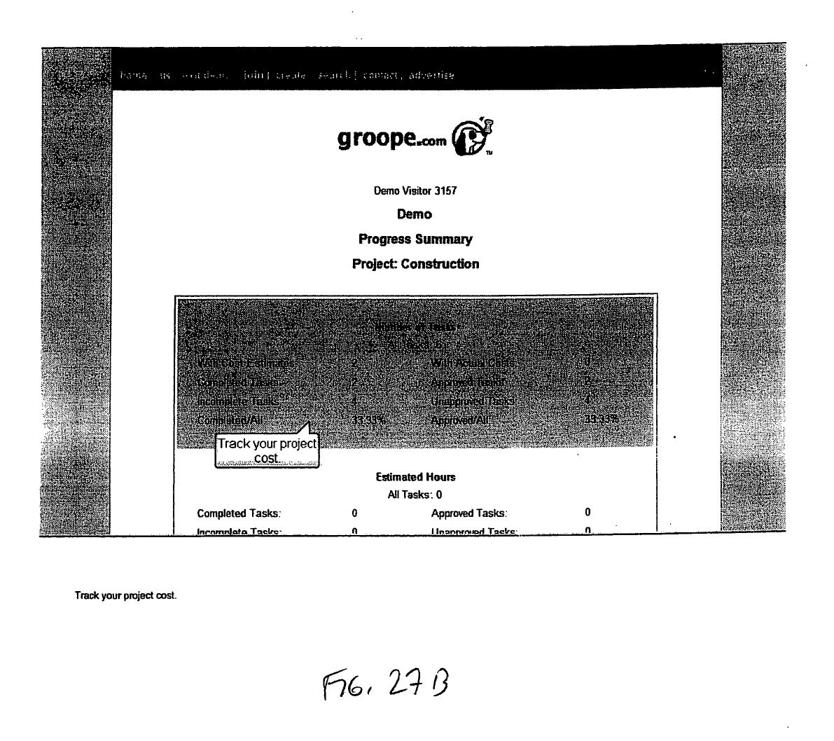

Referring to FIGS. 27A-27B, a progress summary page 400 helps users track project progress and keep on budget. Page 400 displays summary 402 for a project's tasks and summary 404 for the estimated hours of the project. In another example, summary 402 includes a history log for estimated, actual, and remaining costs and summary 404 includes a history log for estimated, actual, and remaining hours. In other examples, page 400 includes a summary of actual hours worked on the project, breaking down hours worked on completed, incomplete, approved, and unapproved tasks as well as tracking what portion of all tasks are completed and what portion of all tasks are approved. Page 400 may also include similar summaries for estimated costs and actual costs. Page 400 may also include summaries of remaining hours and remaining costs for incomplete tasks.

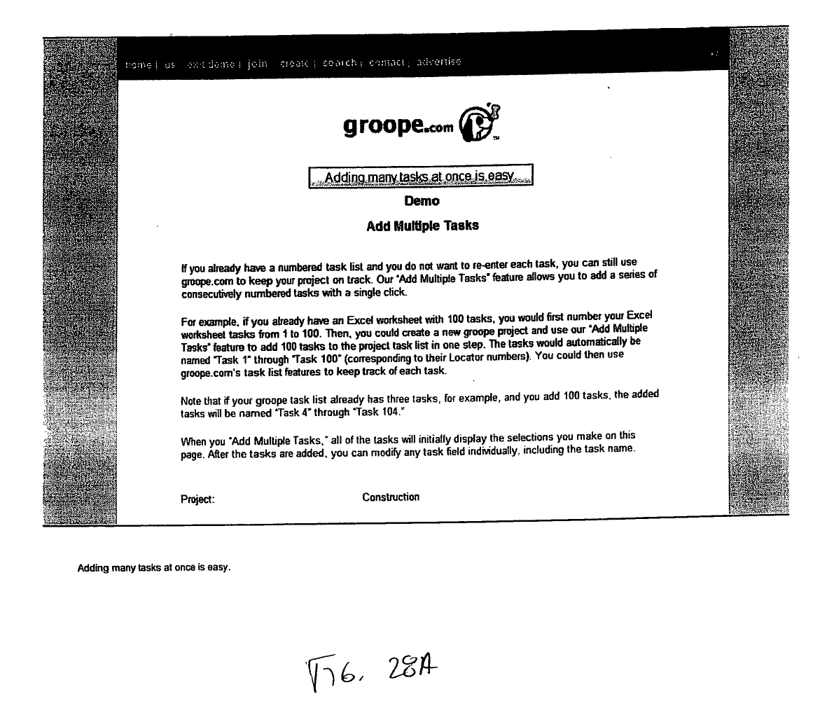

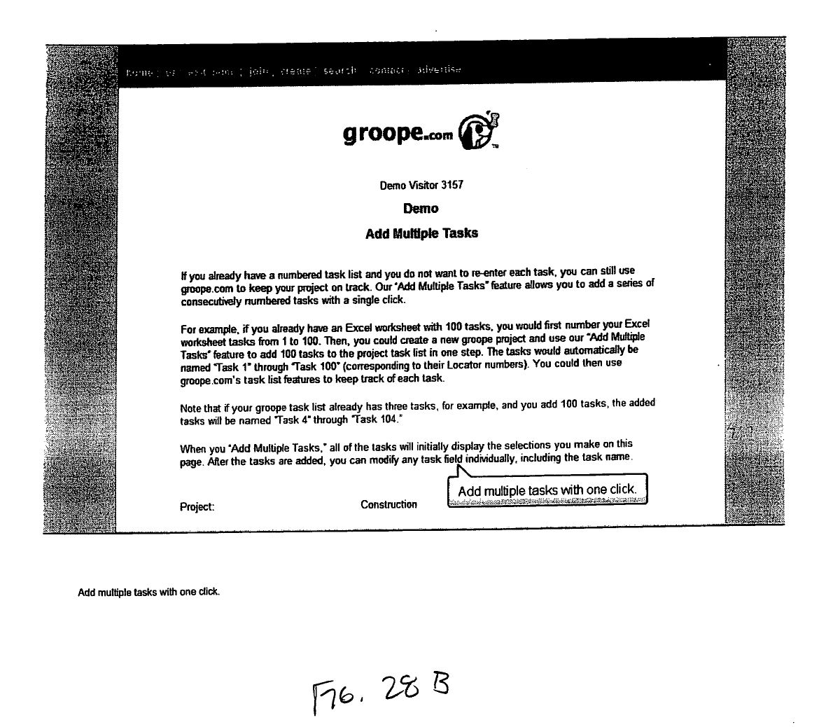

Referring to FIGS. 24H and 28A-28B, a user can add multiple tasks to the task list at one time by clicking on button 410. If the user already has a numbered task list and does not want to reenter each task, she can use the multiple tasks embodiment of the present invention to add a series of consecutively numbered tasks with a single click. For example, if the user already had a spreadsheet with 100 tasks, she would first number the spreadsheet tasks from 1 to 100. Then, she would create a new project and add the spreadsheet tasks to the new project in one step. The imported tasks would automatically be numbered “Task 1” through “Task 100,” corresponding to the spreadsheet numbering. If there were existing tasks on the task list, the imported tasks would be numbered starting with the next available task number. Once the multiple tasks are added to the list, they initially display the selections made on the add multiple tasks page. After the tasks are added, a user can modify any task field individually, including the task name.

Referring to FIG. 24H, task list data may be exported to other programs, such as a spreadsheet program, by clicking on button 412 and exporting the file in a well-known format, such as a comma separated file.

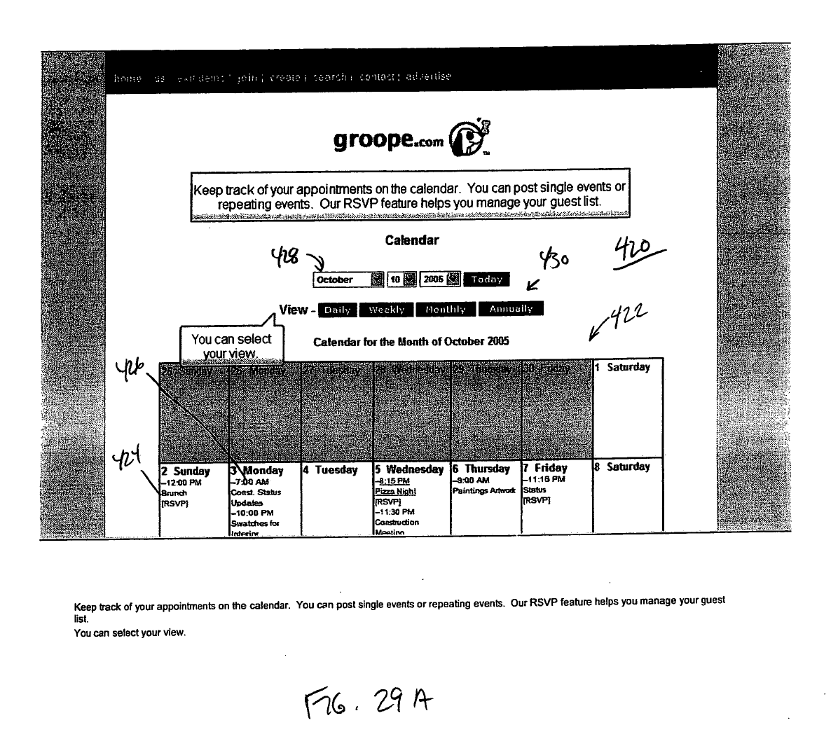

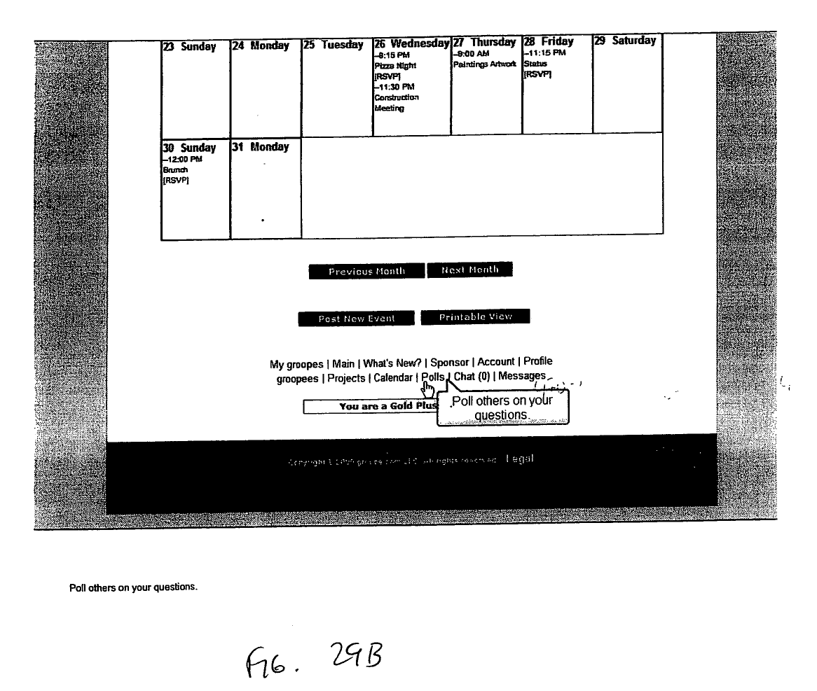

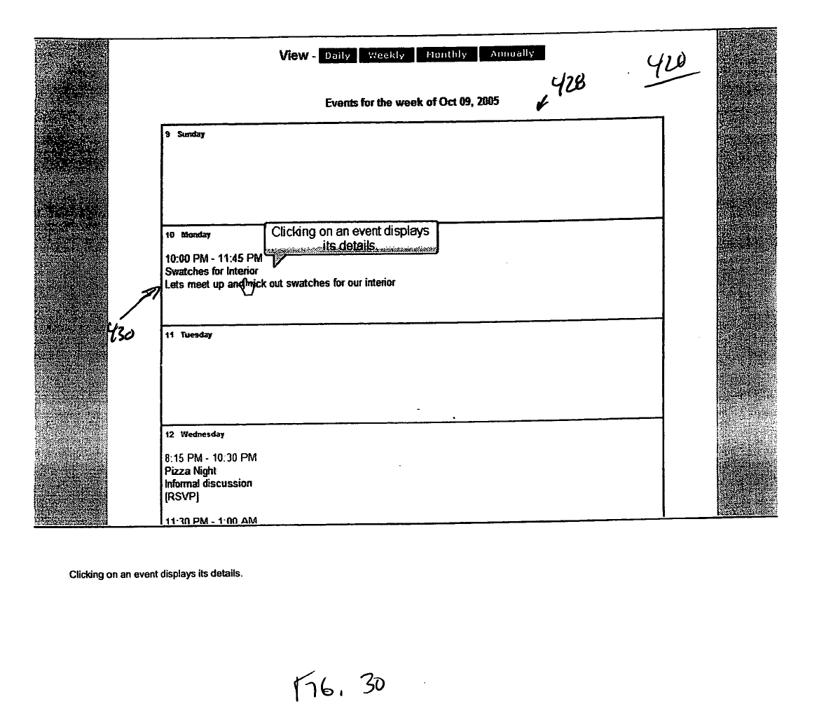

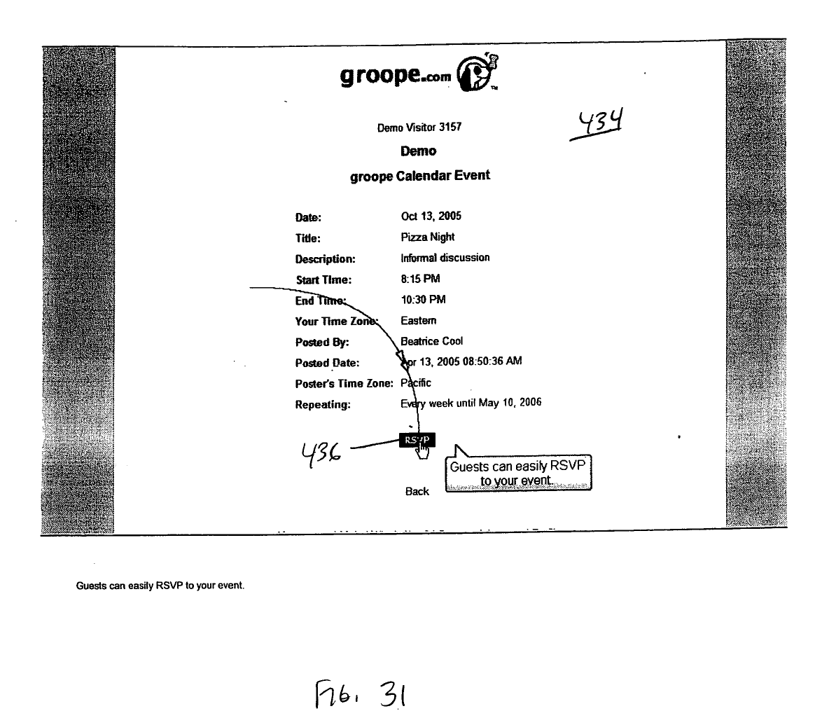

Referring to FIGS. 29A-29B and 30-31, user can keep track of his appointments on a calendar 422 displayed on page 420. The user can post single events, such as “Brunch” appointment 424, or repeating events, such as “Const. Status Updates” appointment 426, for example. The user can quickly select a date to display with pull downs 428 and select a view to display with buttons 430, such as a daily, weekly, monthly, or annual view, for example. Calendar 428 shows a weekly view. A user can click on an event 430 in calendar 428 to view the event's details on page 434. At the bottom of page 434, a user may RSVP to the event 430 by clicking on RSVP button 436. The user may also RSVP by clicking on an RSVP link next to the event description in any view. For a repeating event, users may RSVP for a single date, for selected multiple dates of the event, or for all dates of the event. When users RSVP, they indicate whether or not they will attend and enter the name and optional email address for each guest. The total number of attendees and the number of guests per member are automatically restricted to the limits entered by the member that established the event.

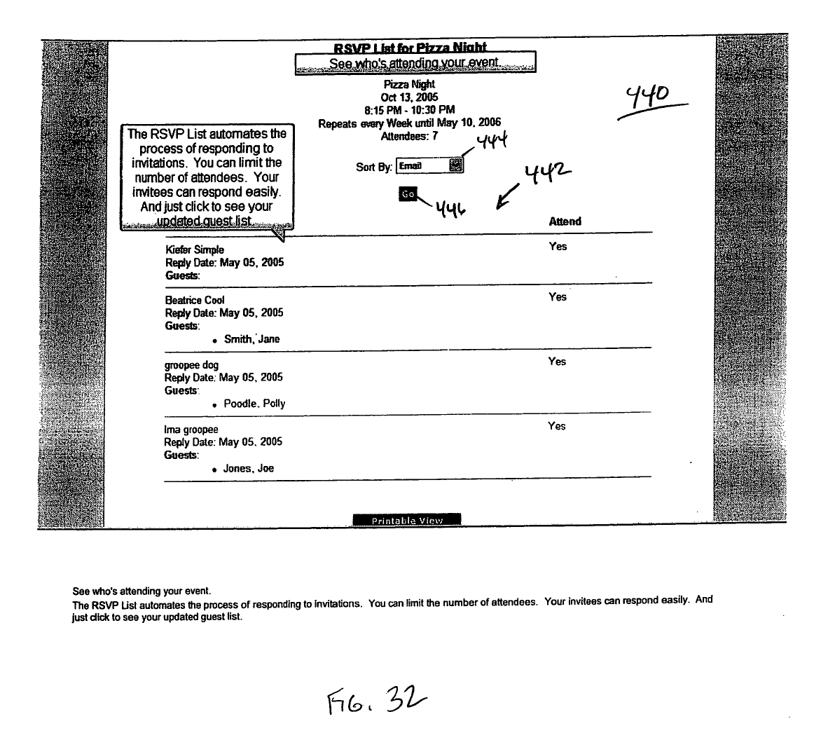

Referring to FIGS. 32, the RSVP list 442 shown on page 440 automates the process of responding to invitations. A user can manage the number of attendees to an event created by her. Invitees can respond easily. Using pull down 444 and clicking button 446 can sort list 442. The RSVP list 442 allows members to sort and list or print which other members are attending the event, who their guests are, when they responded, and optional email addresses. The RSVP list also displays the total number of members and the total number of guests that will be attending.

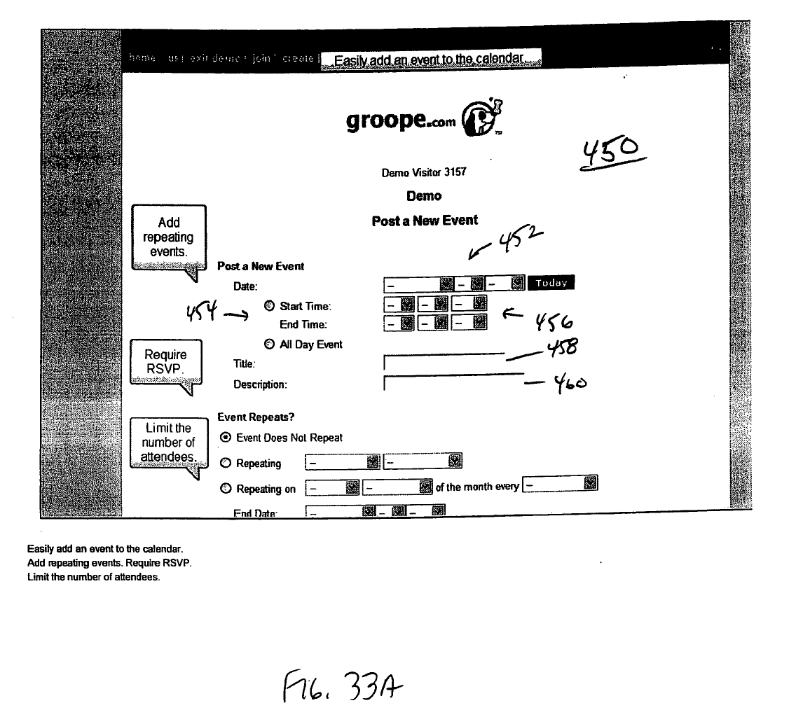

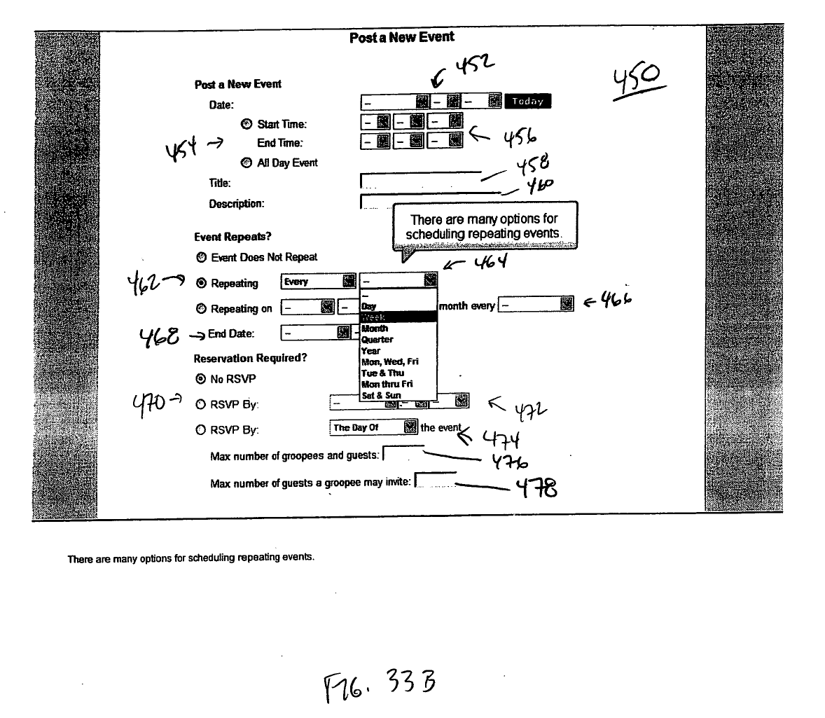

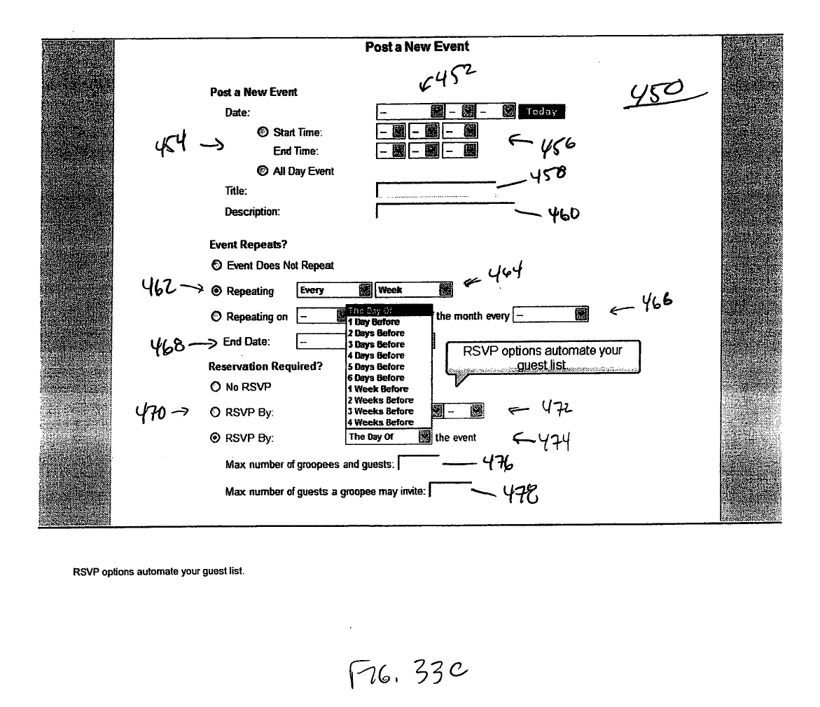

Referring to FIGS. 33A-33C, new events may be added to calendar 422 on page 450. Pull downs 452 control the date for the new event while radio buttons 452 control whether the event has start and end times (controlled by pull downs 456) or is an all day event. The event title and description are entered in fields 458 and 460, respectively. Radio buttons 462 control the event's repeating properties (e.g., not repeating, repeating by time period, or repeating by a property of the date) and pull downs 464 and 466 control those properties. Pull downs 468 control whether a series of repeating events has an end date. Radio buttons 470 control whether guests must respond to events with a reservation (i.e., RSVP) to attend and pull downs 472 and 474 control when an invitee must respond by in order to attend. Entering values in fields 476 and 478 controls the maximum number of attendees and maximum number of guests a group member may bring.

By integrating calendar 422 with an automated, easy-to-use RSVP list 442 in a community setting, users have a powerful tool to manage schedules and automate guest lists for meetings and events.

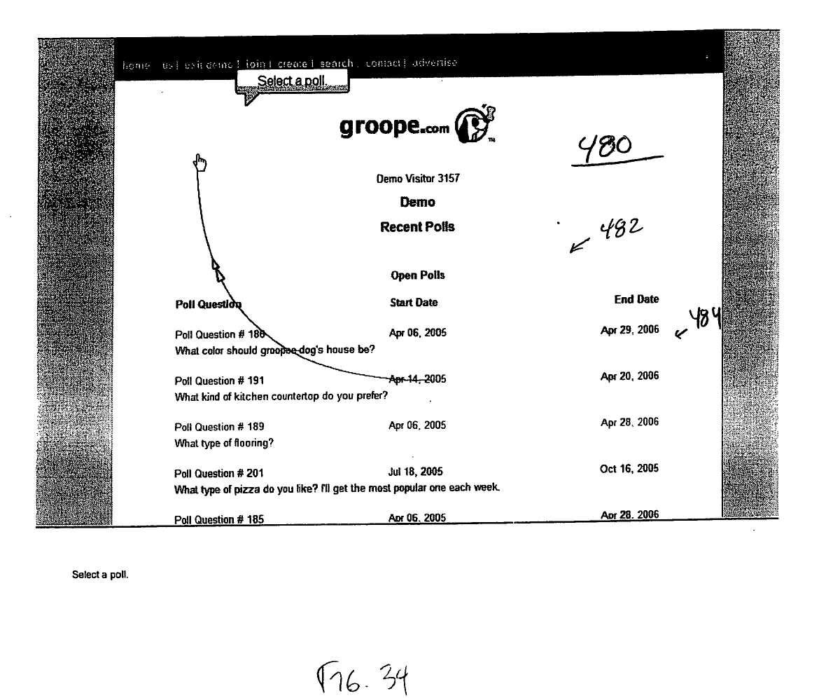

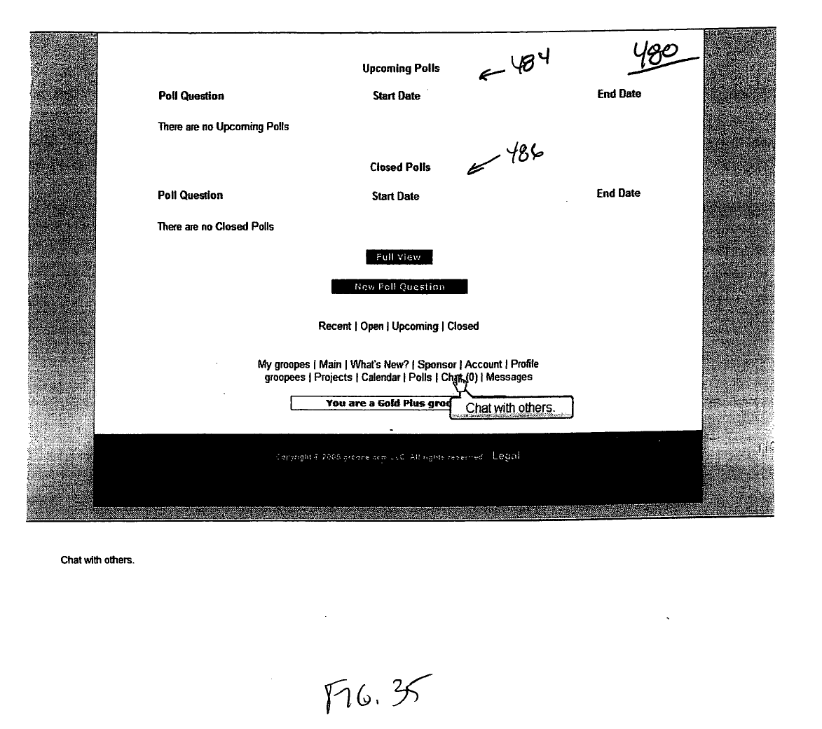

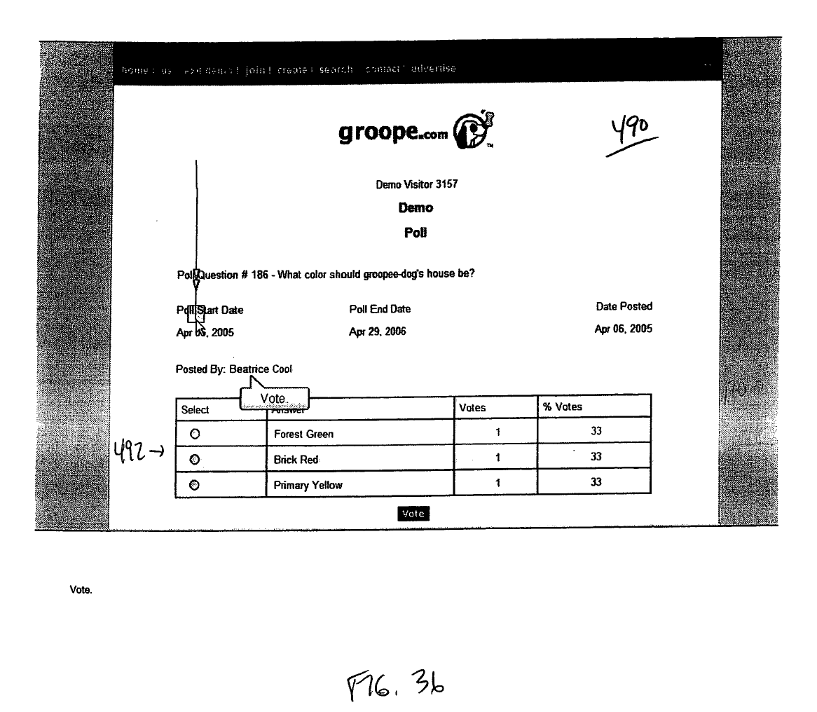

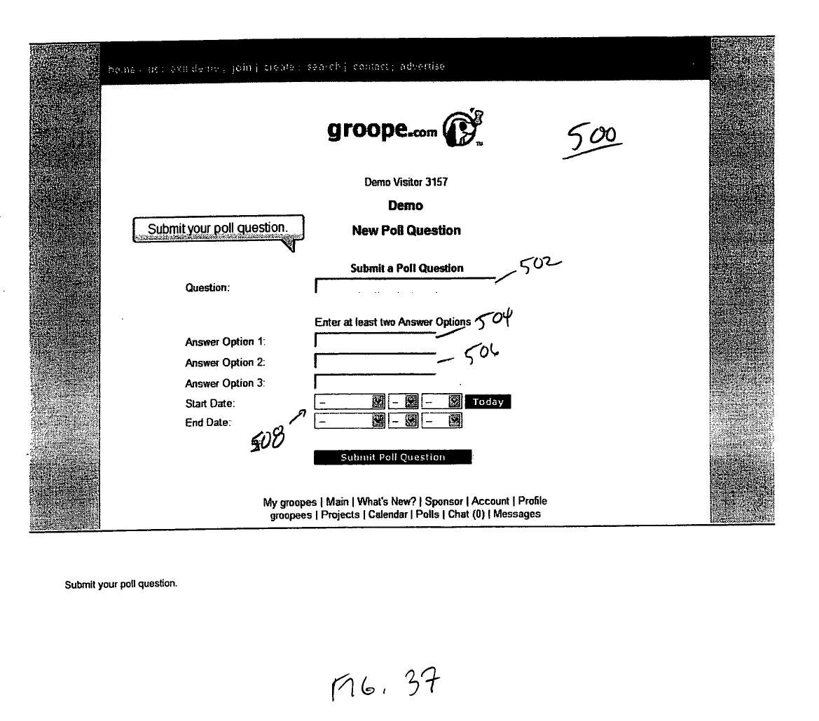

Referring to FIGS. 34-37, group members may use polls to let group members vote on questions posed therein. Page 480 shows a list 482 of recent polls for a particular group. List 482 includes polls that are currently open, polls 484 that have not yet opened for voting, and polls 486 that have been voted on in the past. In one example, the poll question and poll start and end dates are displayed for each poll on the list. Each poll listed is linked to a page 490 on which the user can submit her vote using radio buttons 492 corresponding to the poll options.

New poll questions are created on page 500. The user enters the poll question in field 502 and at least two answer options in fields 504 and 506. Additional fields may contain additional poll answer options. Pull downs 508 control the poll's start and end dates.

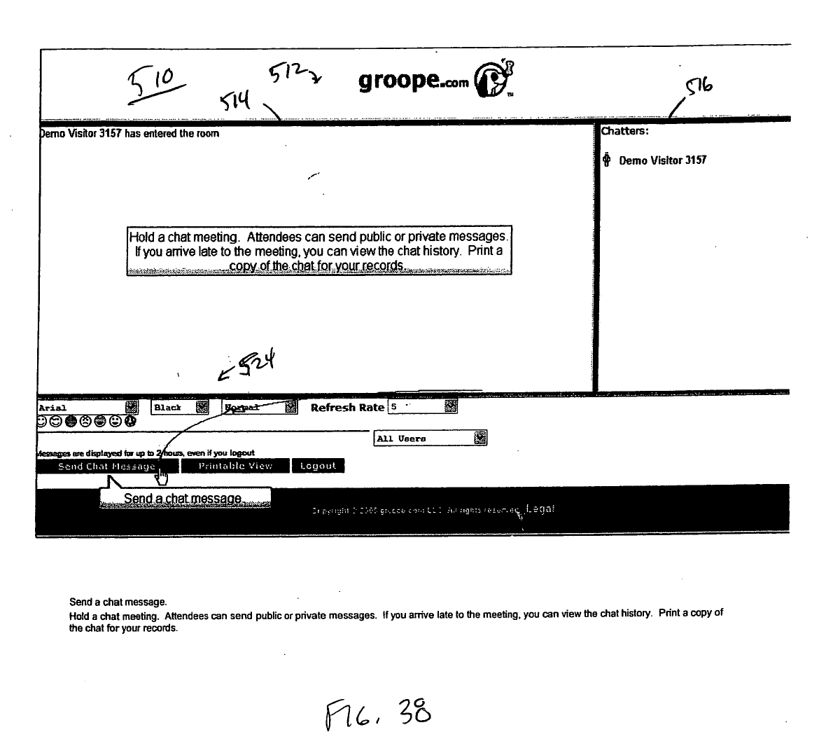

Referring to FIG. 38, group members may participate in online chat with each other. Each group has its own chat room. By entering chat room 512 on page 510, two or more members may hold chat meetings, send public or private messages in the chat room, view all or a portion of chat history, and print copies of all or a portion of chat history for their records. The chat history is displayed for a period of time, so that users subsequently entering the chat room can view what has transpired. Frame 516 lists the chat participants while the chat history appears in frame 514. The names of the chat participants can be clicked to view their profiles.

A member enters his chat message in field 518, controls who will see the chat message with pull down 520, and sends the message by clicking button 522. In other examples, check boxes appearing next to each name in chat may be selected to determine who receives a chat message. A member can also elect to ignore the chat messages of selected members and those messages will not be displayed. Pull downs 524 control how the chat appears in frame 514 (e.g., font, size, and color). In other examples users can attach thumbnail images to their chat posts, which are clickable for full-size. Users may insert links in their chat posts to calendar events, polls, messages on a message board, or web pages.

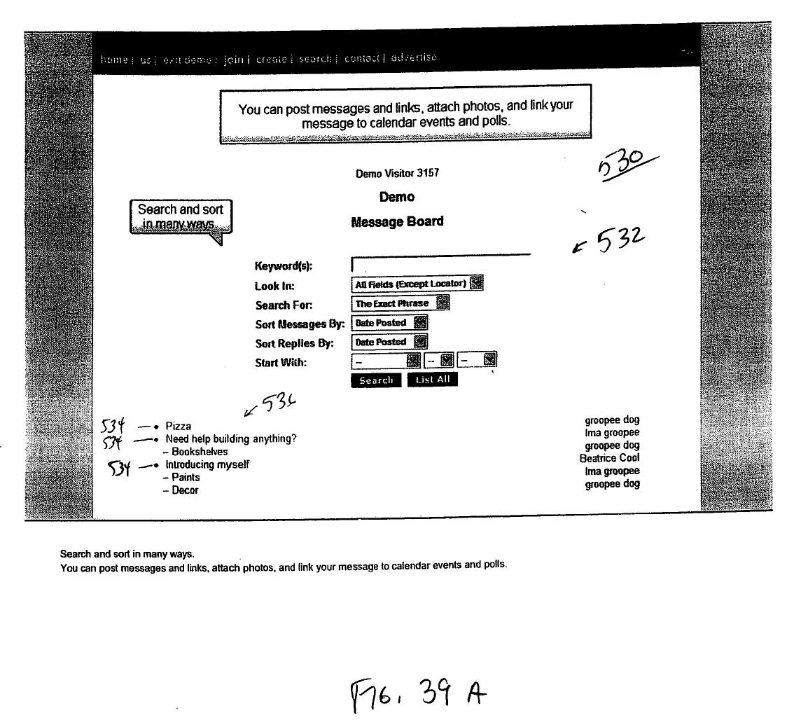

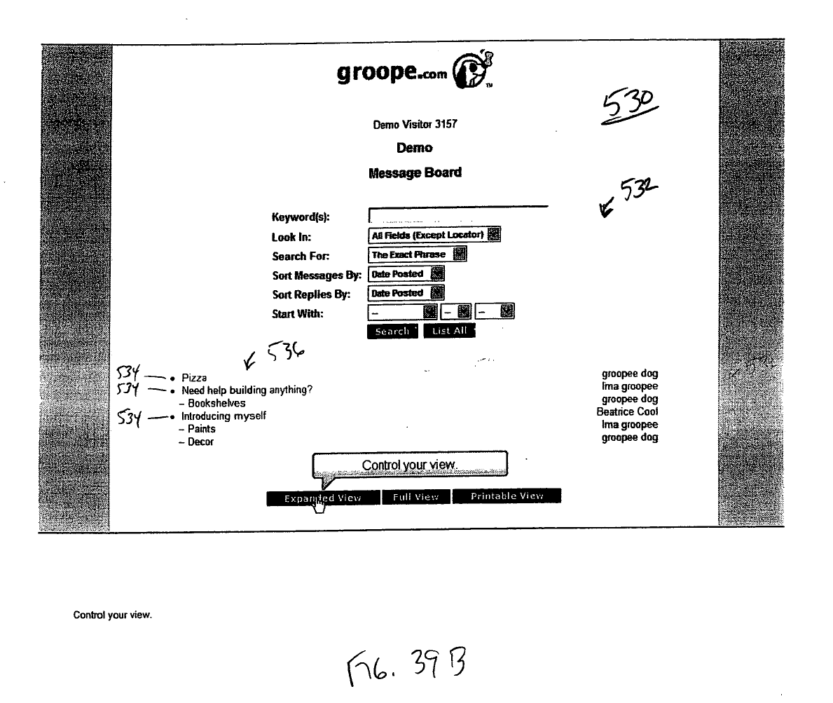

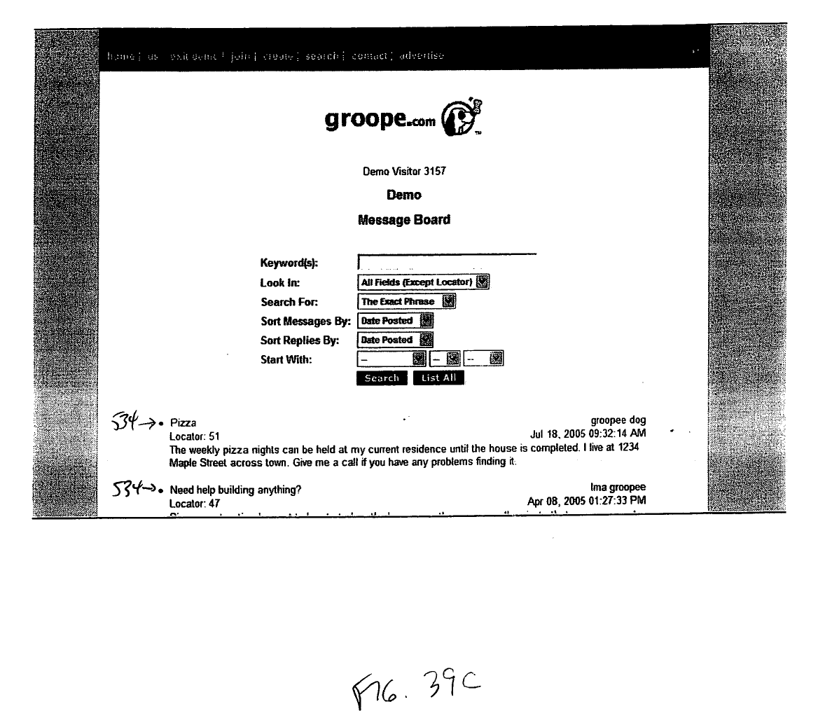

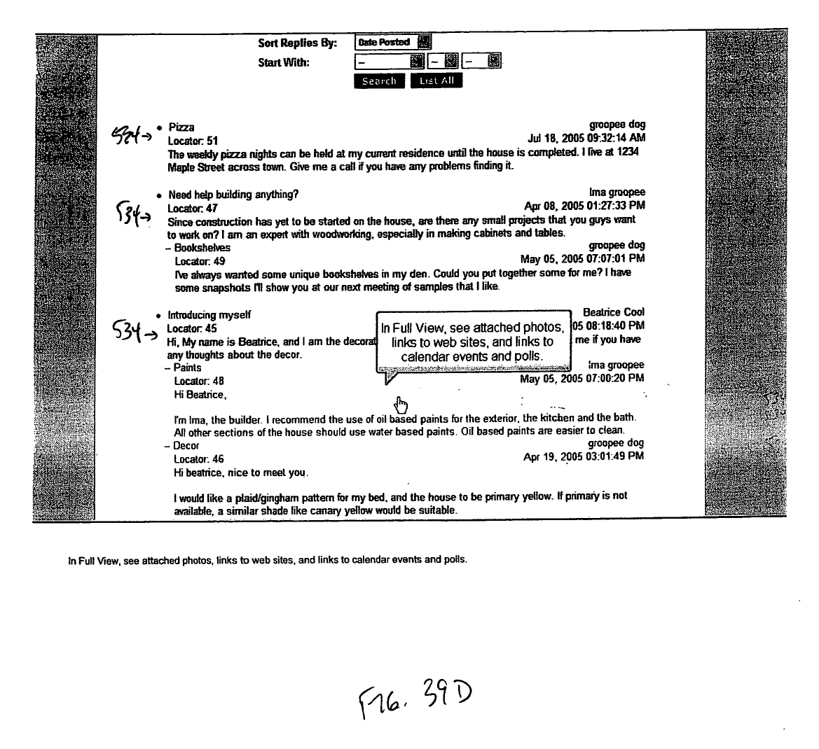

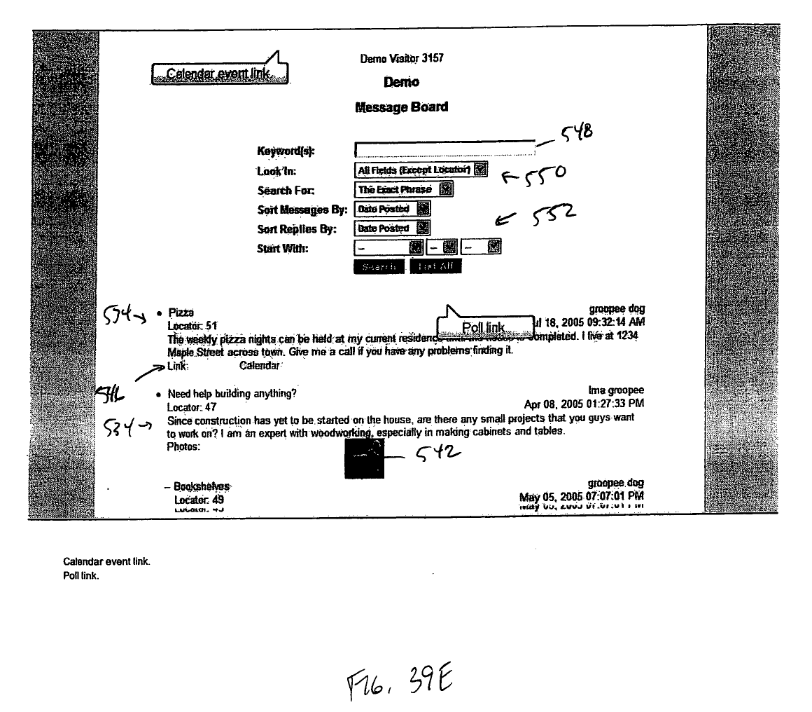

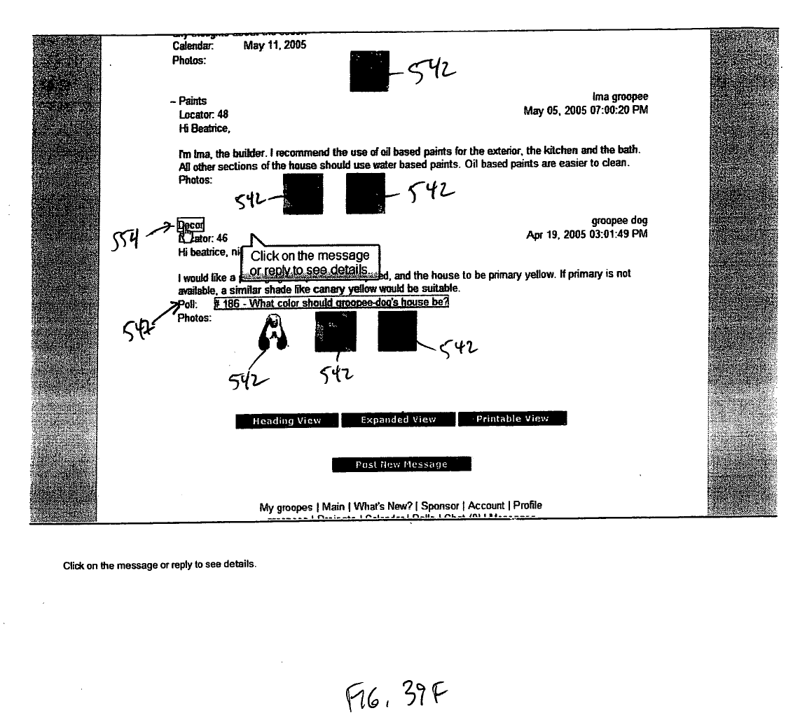

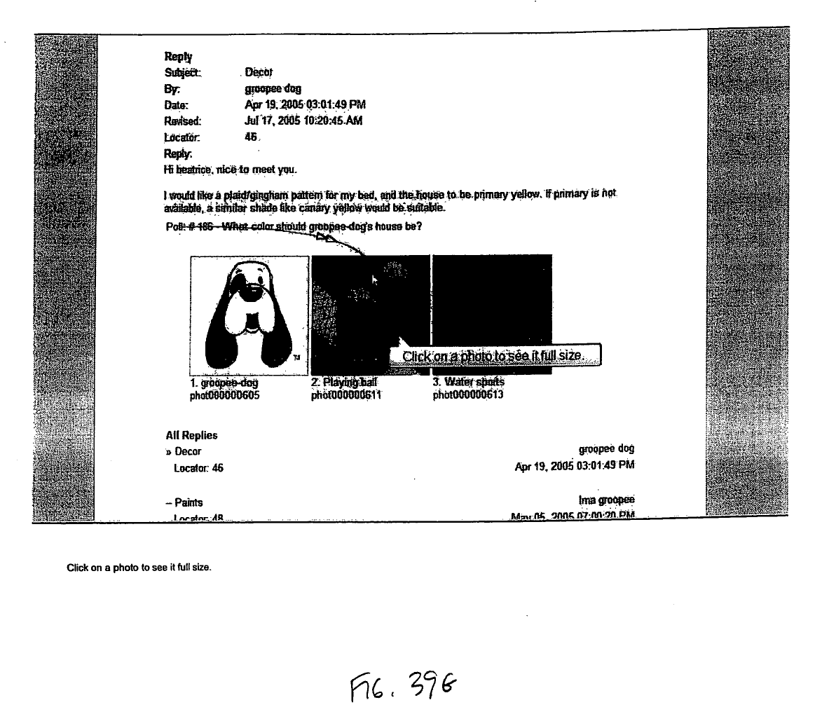

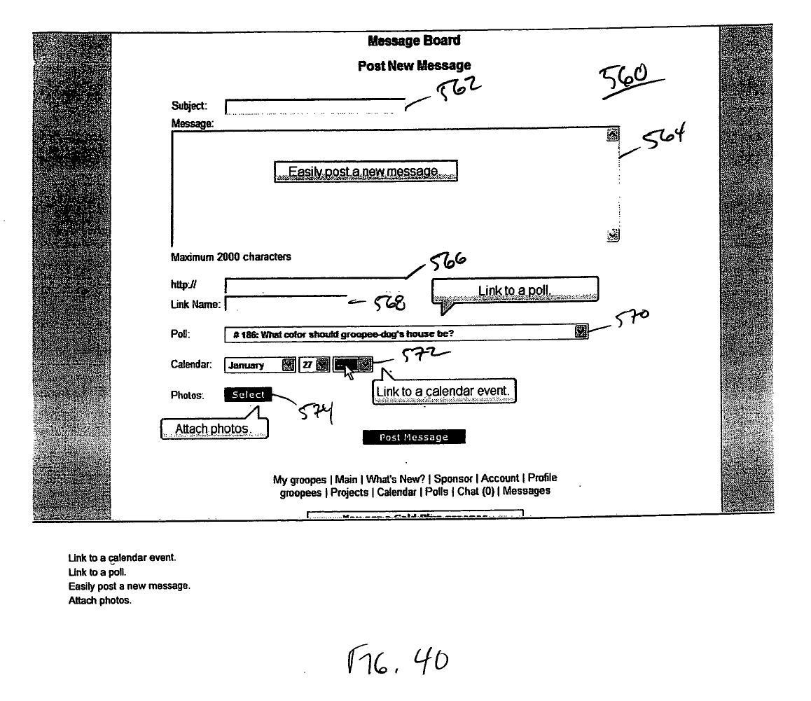

Referring to FIGS. 39A-39G, and 40 a message board 532 on page 530 is another way for users to communicate within a group. Messages 534 may be displayed in a summary view 536 of headings only, an expanded view 538, with the message body shown, or a full view 540 with thumbnails 542 linked to attached photos and links to other message attachments, such as calendar event 546, poll 547, web sites, or other links. Message board 532 is searched by entering keyword(s) in field 548, choosing search parameters with pull downs 550, and choosing search result display parameters with pull downs 552. Clicking on a message link 554 shows the details 556 of message 534.

New messages are composed on page 560. A message subject and body are entered in fields 562 and 564 respectively. HTTP links may be entered in field 566. A name for the link may be entered in field 568. Poll links are chosen using pull down 570 and calendar links are chosen with pull downs 572. Photos from a user's photo gallery may be attached by clicking button 574.

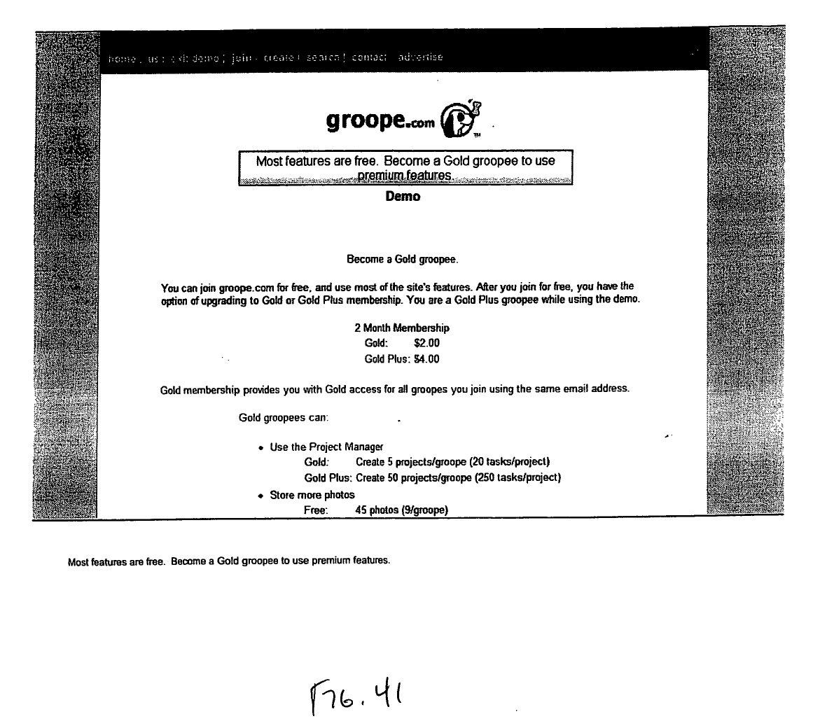

Referring to FIG. 41, one embodiment of the present invention has at least two levels of membership. In one example, “Gold” members have access to all features of the embodiment while regular members do not, such as being restricted from project and task list features. In another example, “Gold” members may be allocated more storage space for personal information, such as pictures. Other levels of membership may be incorporated.

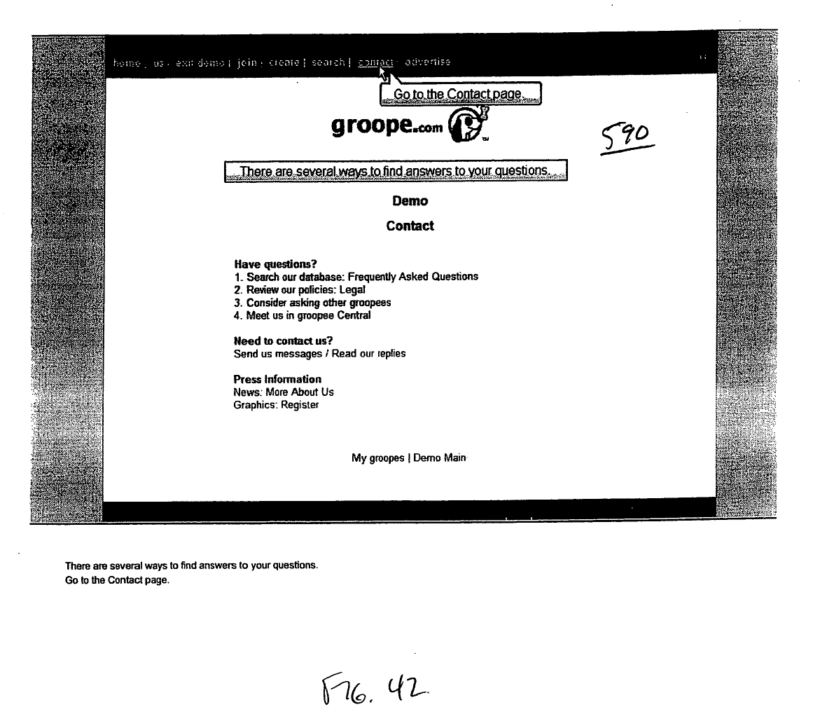

Referring to FIG. 42, page 590 offers users information about the community. Users can search a database of frequently asked questions, review legal policies, or ask other group members in a private message or on a public message board. A user can send messages to a the site's administrator and read replies. Press release and other public information may be access from page 590.

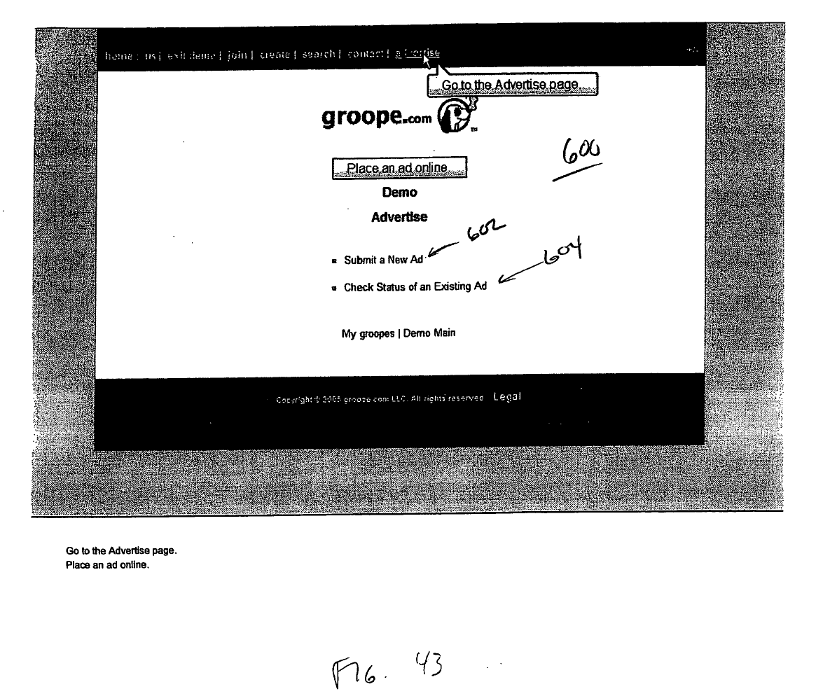

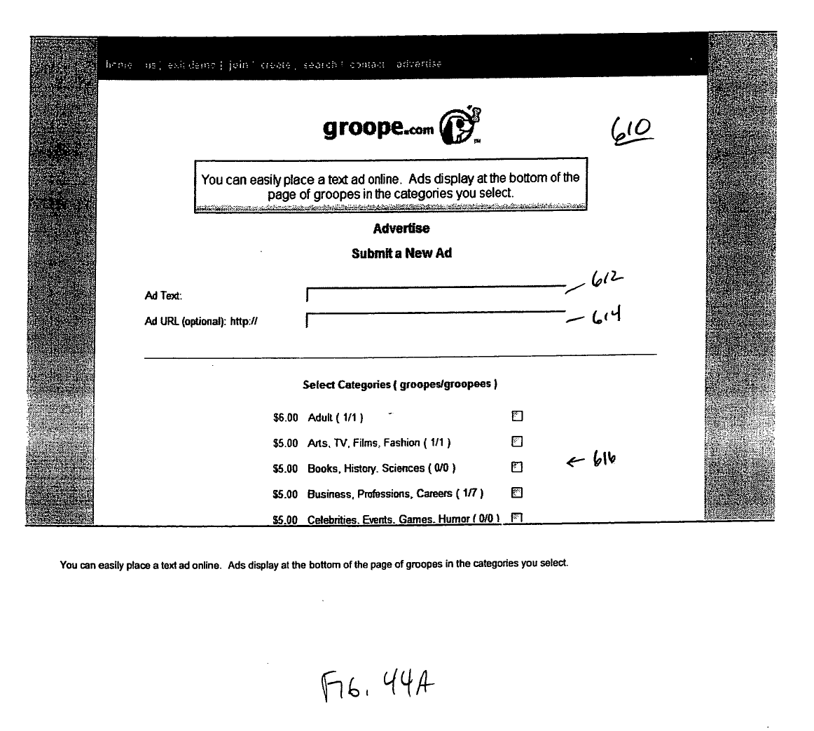

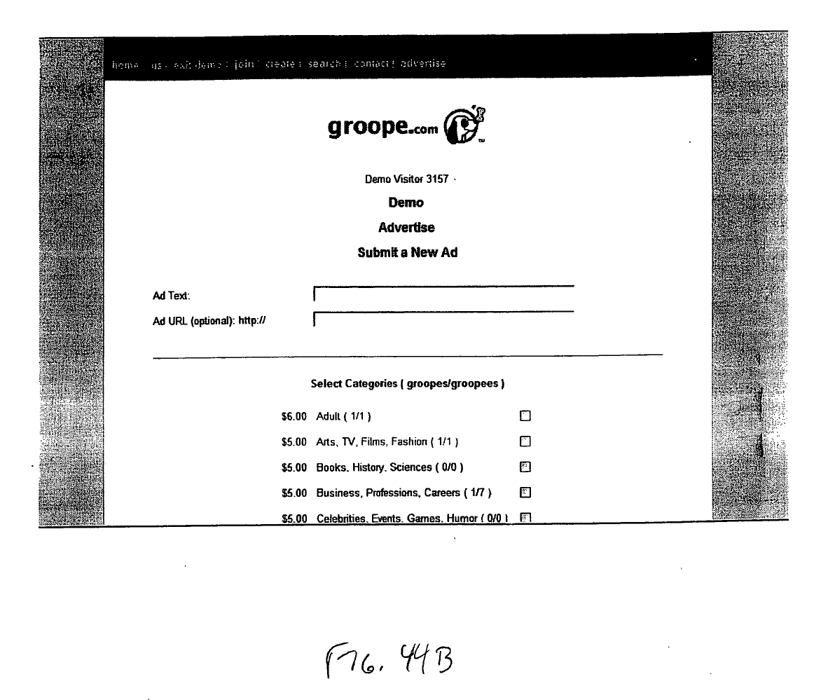

Referring to FIGS. 43 and 44A-44B, anyone may advertise, subject to approval by the site's administrators, in one or more selected communities or categories of communities by clicking on link 602 or check on her existing advertisements by clicking on link 604 found on page 600. On page 610, ad text is entered in field 612 and an optional URL may be entered in field 614. Checkboxes 616 control which categories in which the advertiser wants the ad included.

The scope of the invention is defined by the claims and their equivalents.

We claim:

1. A method of participating in a community of members, the method comprising:
joining a group of members having in common at least one interest;
interacting with the members using one or more of chat, email, or message boards;
managing a group calendar, including comprising adding new events to the calendar, inviting group members to the events, responding to invitations, and managing a list of event participants; and
managing a group project, including adding and modifying tasks, tracking progress of task completion, and generating a summary of task statuses.
